(19) United States
(12) Patent Application Publication
(10) Pub. No.: US 2013/0301863 A1
(43) Pub. Date: Nov. 14, 2013

(54) HAND-HELD ELECTRONIC DEVICE AND/OR COVER FOR A HAND-HELD ELECTRONIC DEVICE

(71) Applicant: NFLUKZ, LLC, Hudsonville, MI (US)

(72) Inventor: Robert W. Weaver, III, Caledonia, MI (US)

(73) Assignee: NFLUKZ, LLC, Hudsonville, MI (US)

(21) Appl. No.: 13/839,744

(22) Filed: Mar. 15, 2013

Related U.S. Application Data
(63) Continuation-in-part of application No. PCT/US2012/035437, filed on Apr. 27, 2012.
Application No. PCT/US2012/035437 is a continuation-in-part of application No. 13/385,588, filed on Apr. 28, 2011.
(60) Provisional application No. 61/621,757, filed on Apr. 9, 2012.
(60) Provisional application No. 61/694,153, filed on Aug. 28, 2012.

(51) Int. Cl. H04R 1/32

(52) U.S. Cl. CPC H04R 1/323
USPC 381/334

(57) ABSTRACT

A cover for a hand-held device or a hand-held device housing includes a channel in communication with a speaker of the hand-held device for redirecting at least a portion of the sound waves emitted from the speaker to a location remote from the speaker.

### TECHNICAL FIELD AND BACKGROUND OF THE INVENTION

The expanding cellular smart-phone and tablet PC devices have given rise to an expanding accessory market focused on providing case covers that serve a primary function of protecting the somewhat delicate devices from scratch, dent, and drop impact damage.

These same devices typically have both an internal headphone jack with which to listen to a listen to music, audible books, interact in phone calls and all other auxiliary audible functions of the devices. Along with the headphone jack, most if not all of these type devices include an internal monophonic or stereophonic set of speakers located somewhere within the device, typically along the perimeter edge or backside of the device.

Due to the extremely tight size and spatial constraints, and vital importance of the front screen face geometry, most of these internal speaker systems provide a minimal sound quality typically from one monophonic speaker sound source. This sound source is typically located upon the back face of the device, or near one extreme edge of the device. In each case, the majority of sound energy is directed away from the primary user of the device. The remaining sound energy that is directed towards the primary device user typically arrives to the user's ear as a weak monotone and asymmetrical sound source that is easily overpowered by moderate ambient perimeter noise. With the ever-expanding use of these devices to play games, listen to music, and, in some cases, to watch movies, a better sound quality would, therefore, be highly desirable.

### SUMMARY OF THE INVENTION

Accordingly, the present invention provides an accessory or component that improves the sound quality of these hand-held devices.

In one form of the invention, a sound concentrator is provided that can be incorporated into a device cover, a device cover insert, or into a device itself to improve the quality of the sound emitted from the speakers or sound emitting devices of the device. In one aspect, this can be achieved without power.

According to another form of the invention, a cover for a hand-held device with a device body and a speaker includes a cover body, which is configured for covering at a portion of the device body and for covering the speaker and which forms an outlet opening. A plenum space is formed by the cover body or by an insert in the cover body, which is in communication with the speaker for directing sound waves or energy from the speaker to the outlet opening.

In one aspect, the cover or an insert for the cover is configured to form a channeled void space that is in communication with the one or more speakers of the device and that channels or redirects the sound waves from the speaker or speakers to a location or locations remote from the speaker, for example, around the perimeter of the device.

In a further aspect, the cover or insert seals around the speaker to capture substantially all, if not all, the sound waves so that the primary sound source energy can be concentrated and redirected to the location(s) remote from the speaker(s) to provide a more concentrated and desired sound quality to the primary use, as compared to what the same device sound source can provide to the primary user without the aid of the sound source manipulating properties of the invention.

In yet a further aspect, the cover is configured to have an impact absorbing configuration. For example, the cover may include portions that are enlarged or spaced from the device when mounted to the device so that the cover will absorb energy upon impact.

In another form of the invention, a cover for a handheld device (with a device body and a speaker) includes a cover body, which is configured for covering at a portion of the device body and for covering the speaker or stereo speaker pair. The cover also includes a channel for communication with the speaker and for directing sound waves from the speaker to an outlet opening formed by the cover body, with the channel having a length and a cross section increasing in magnitude along the length of the channel for harnessing and concentrating the sound emitted from the speaker and directing the sound waves to the outlet opening.

In one aspect, the cover body forms a plenum space, with the channel in communication with the plenum space for directing the sound waves to the plenum space, which is in communication with the outlet opening.

In another aspect, the cover body includes a base wall and a perimeter wall. The perimeter wall extends around and from the base wall and forms the opening and also an outlet chamber about the opening for positioning adjacent a portion of the device body.

In a further aspect, the side wall of the cover body forms the outlet chamber at a corner of the cover for positioning adjacent a corner of the device.

According to another aspect, the side wall of the cover body forms at least three outlet chambers located around the perimeter of the device body.

In yet another aspect, the cover body includes a base wall and a perimeter wall, with the base wall having the opening.

According to yet another aspect, the channel is formed by a pair of side walls, which diverge in the direction of the plenum space.

Optionally, the cover further includes a second channel, the second channel in communication with the plenum space and the same or another outlet opening for directing the sound waves from the plenum space to the same or other opening. Similarly, the second channel may be formed by a pair of side walls, which diverge in the direction of the same or other opening.

According to yet other aspects, any of the covers noted above may be formed, such as by molding or stamping, and may be formed from a rigid material, such a metal or plastic, or may be formed from a semi-rigid material, such as an elastomeric polymer, or from a non-rigid material, such a rubber or an elastomeric material, including a silicone based material, polycarbonate or a thermoform polyurethane (TPU).

In addition, the covers may be made from several materials and also may be formed from two or more components.

In yet other aspects, a secondary lower density material may be provided as the contact surfaces between the device outer surface, and the cover to serve as an air tight and sound isolating sealant or gasket. The sealant material may be attached by adhesives, mechanically attached, or applied within a secondary molding process or within the primary molding process of a semiflex material. By use of a sealant to isolate the sound energy of the primary sound source speaker(s) mono or stereo, it will be possible to create a more efficient manipulation and redirection of the finite sound energy available with the device.

Accordingly, the present invention provides a sound concentrator that can be incorporated into a cover or into a device itself to improve the quality of the sound emitted from the speakers or sound emitting devices of the device.

In yet another form of the invention, an electronic hand-held device includes a device body and a speaker. The device body has a channel which has a closed cross section for harnessing and concentrating sound waves (energy) emitted by the speaker and for directing sound waves from the speaker to an outlet chamber spaced from the speaker.

According to another form of the invention, a cover for a handheld device with a device body and a speaker includes a cover body, which is configured for covering at a portion of the device body and for covering the speaker and which forms an outlet opening. A plenum space is formed by the cover body or by an insert in the cover body, which is in communication with the speaker for directing sound waves from the speaker to the outlet opening and which increases the perceived volume of the speaker optionally without power.

In one aspect, the cover body or insert is adapted to absorb and thereby filter a selected range of frequencies of the sound wave. For example, the cover body or insert may include a material or structure that absorbs and thereby filters the selected range of frequencies of the sound wave. The cover body or insert may include a coating applied thereto that absorbs and thereby filters the selected range of frequencies of the sound wave.

In another aspect, the cover also includes a channel, which is in communication with the plenum space and the speaker for harnessing and concentrating sound waves emitted by the speaker. The plenum space is in direct communication with the outlet opening or indirect communication with the outlet opening by way of another channel.

In yet another form of the invention, an electronic hand-held device includes a housing with an outlet opening, a speaker spaced from the outlet opening, and a plenum space in communication with the speaker and the outlet opening for directing sound waves emitted from the speaker to the outlet opening.

In one aspect, the device further includes a channel that is in communication with the speaker and the plenum space for harnessing and concentrating the sound waves emitted from the speaker. For example, the channel may have a closed cross-section that increases in magnitude in the direction from the speaker to the plenum space which increases the perceived volume of the speaker optionally without power.

In yet another form, a method of directing sound from a speaker in a hand-held device includes harnessing the sound waves emitted from the speaker, adjusting the sound waves, and outputting the adjusted sound waves at a location spaced from the speaker optionally without power.

For example, the adjusting may include concentrating the sound waves at the location or concentrating the sound waves at two or more locations spaced from the speaker. In another or additional aspect, the adjusting includes absorbing a selected frequency of the sound waves to thereby filter the selected frequency. In addition, the sound waves may be guided along a channel with an increasing cross-section to thereby increase the perceived volume of the speaker optionally without power.

Accordingly, when mounted to or in a handheld device with one or more speakers, the plenum space or channels of the present invention provide improved sound volume and/or quality.

These and other objects, advantages, purposes, and features of the invention will become more apparent from the study of the following description taken in conjunction with the drawings.

### DESCRIPTION OF THE FIGURES

FIG. 1 is a perspective view of a cover of the present invention shown mounted to a handheld device in the form of a cell phone;

FIG. 2 is a second perspective view of the cover and handheld device of FIG. 1;

FIG. 3 is a top plan view of the cover and handheld device of FIGS. 1 and 2;

FIG. 4 is a side elevation view of the cover and device of FIG. 1;

FIG. 5 is a right side elevation view of the cover and device of FIG. 3;

FIG. 6 is a left end elevation view of the cover and device of FIG. 1;

FIG. 7 is a right end elevation view of the cover and device of FIG. 1;

FIG. 8 is a perspective view of the cover of FIG. 2 with the handheld device removed to show the internal structure of the cover;

FIG. 9 is a cross section view of the cover and device taken through line IX-IX of FIG. 1;

FIG. 10 is an enlarged view of detail X of FIG. 9;

FIG. 11 is a bottom plan view of the cover of FIG. 9;

FIG. 12 is a similar view to FIG. 11 with the channel shown in phantom lines;

FIG. 13 is an exploded perspective view of the cover of FIG. 8 illustrating a two-piece construction of a cover;

FIG. 14 is a bottom exploded perspective view of the cover of FIG. 13;

FIG. 15 is a perspective view of another embodiment of a cover of the present invention shown mounted over a handheld device, such as a cell phone;

FIG. 16 is a top plan view of the cover and device of FIG. 15;

FIG. 17 is a bottom perspective view the cover and device of FIG. 15;

FIG. 17A is a similar view to FIG. 17 showing shading of the cover;

FIG. 18 is a another perspective view of the cover and device of FIG. 17;

FIG. 19 is another perspective view of the cover and device of FIG. 15;

FIG. 20 is a side elevation view of the cover and device of FIG. 15;

FIG. 21 is a right side elevation view of the cover and device of FIG. 15;

FIG. 22 is a top perspective view illustrating the cover with the device removed to show the inwardly facing side of the bottom wall of the cover;

FIG. 23 is a second perspective of the cover of FIG. 21;

FIG. 24 is a bottom plan view of the cover of FIG. 20;

FIG. 25 is a top plan view of another embodiment of the cover of FIG. 16 illustrating the cover incorporating sound emitting openings in the forward facing side of the cover;

FIG. 26 is a plan view of another configuration of the cover of the present invention, which is adapted for covering the back side of another handheld device, such as a pad;

FIG. 27 is yet another embodiment of the cover of the present invention also configured for covering the back side of a handheld device in the form of a pad; and

FIG. 28 is another embodiment of the cover of the present invention configured for covering the back side of a handheld device, such as a pad.

FIG. 29 is a perspective view of another embodiment of a cover of the present invention shown mounted to a handheld device in the form of a cell phone;

FIG. 30 is a top plan view of the cover with the device removed to show the internal structures of the cover;

FIG. 31 is a bottom plan view of the cover of FIG. 30;

FIG. 32 is a side view of the cover of FIG. 30;

FIG. 33 is an end view of the cover of FIG. 30;

FIG. 34 is another end view of the cover of FIG. 30;

FIG. 35 is another side view of the cover of FIG. 30;

FIG. 36 is a plan view of another embodiment of the cover shown mounted to a handheld device (shown in phantom);

FIG. 37 is a plan view of the cover with the device removed to show the internal structures of the cover;

FIG. 38 is a perspective view of the cover of FIG. 36;

FIG. 39 is a bottom plan view of the cover of FIG. 36;

FIG. 40 is a side elevation view of the cover of FIG. 36;

FIG. 41 is a cross section view taken along line XIII-XIII of FIG. 36;

FIG. 42 is a fragmentary view of the cover of FIG. 36;

FIG. 43 is a cross section view taken along line XV-XV of FIG. 36;

FIG. 44 is a cross section view taken along line FIG. XVI-XVI of FIG. 36;

FIG. 45 is a side view of the cover of FIG. 36;

FIG. 45A is an exploded perspective view of a modified version of the cover;

FIG. 45B is a perspective view of the cover of FIG. 45A;

FIG. 45C is a cross-section through the cover of FIG. 45A;

FIG. 45D is an enlarged fragmentary view of the cover of FIG. 45A;

FIG. 46 is a plan view of another embodiment of the cover of the present invention shown mounted to a handheld device in the form of a cell phone;

FIG. 47 is a perspective view of the cover of FIG. 46 removed from the handheld device illustrating the internal structure of the cover;

FIG. 48 is a top plan view of the cover of FIG. 47;

FIG. 49 is a bottom plan view of the cover of FIG. 47;

FIG. 50 is a side view of the cover of FIG. 47;

FIG. 51 is another side view of the cover of FIG. 47;

FIG. 52 is an end view of the cover of FIG. 47;

FIG. 53 is a perspective view of another embodiment of a cover the present invention mounted to a handheld device in the form of a cell phone;

FIG. 54 is a perspective view of the cover removed from the handheld device illustrating the internal structures of the cover;

FIG. 55 is an exploded perspective view of the cover of FIG. 54;

FIG. 56 is an enlarge perspective view of the bottom half of the cover of FIG. 54;

FIG. 57 is a perspective view of another embodiment of a cover the present invention mounted to a handheld device in the form of a cell phone;

FIG. 58 is a perspective view of the cover removed from the handheld device illustrating the internal structures of the cover;

FIG. 59 is a perspective view of the back of the cover of FIG. 58;

FIG. 60 is another perspective view of the back of the cover of FIG. 58;

FIG. 61 is a perspective view of a device incorporating the sound wave harness and concentrating technology of the present invention;

FIG. 62 is an exploded perspective view of the removal of a standard back panel and front panel of a device and replacement with a back panel and front panel of the present invention incorporating the sound wave harness and concentrating technology of the present invention; and

FIG. 63 is a respective view of yet another embodiment of the cover of the present invention;

FIG. 64 is another perspective view of the cover of FIG. 63;

FIG. 65 is a rear perspective view illustrating the cover incorporating a stand to position the hand-held device in either a vertical orientation or a horizontal orientation;

FIG. 66 is an enlarged perspective view of the stand;

FIG. 67 is a perspective view of an arm band incorporating a magnet for mounting the cover with the present invention;

FIG. 68 is an exploded perspective view of the removal of a standard back panel and front panel of a device and replacement with a back panel and front panel of the present invention incorporating the sound wave harness and concentrating technology of the present invention;

FIG. 69 is a perspective view of another embodiment of a cover shown mounted to a handheld device;

FIG. 70 is a plan view of the cover in FIG. 68;

FIG. 71 is a bottom plan view of the cover of FIG. 68;

FIG. 72 is a bottom plan view of the cover of FIG. 68 with the device removed;

FIG. 73 is a perspective view of the cover with the device removed to show the internal structures of the cover;

FIG. 74 is another perspective view of the cover with the device removed to show the internal structures of the cover;

FIG. 75 is a side view of the cover of FIG. 69;

FIG. 76 is another side view of the cover of FIG. 69;

FIG. 77 is an end view of the cover of FIG. 69;

FIG. 78 is another end view of the cover of FIG. 69;

FIG. 79 is a cross-section through the cover of FIG. 68;

FIG. 80 is a rear plan view illustrating a cover incorporating another embodiment of a stand to position the hand-held device in either a vertical orientation or a horizontal orientation;

FIG. 81 is a perspective view of the stand shown in its deployed position;

FIG. 82 is an enlarged perspective view of the stand;

FIG. 83 enlarged perspective view of the stand;

FIG. 84 is an enlarged fragmentary view of detail A of FIG. 80;

FIGS. 85 and 86 are other enlarged fragmentary views of detail A of FIG. 80;

FIG. 87 is a rear plan view illustrating another cover incorporating a stand similar to the stand in FIG. 80; and

FIG. 88 is a rear plan view illustrating another cover incorporating another embodiment of a stand to position the hand-held device in either a vertical orientation or a horizontal orientation.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### DETAILED DESCRIPTION OF THE PREFERRED EMBODIMENTS

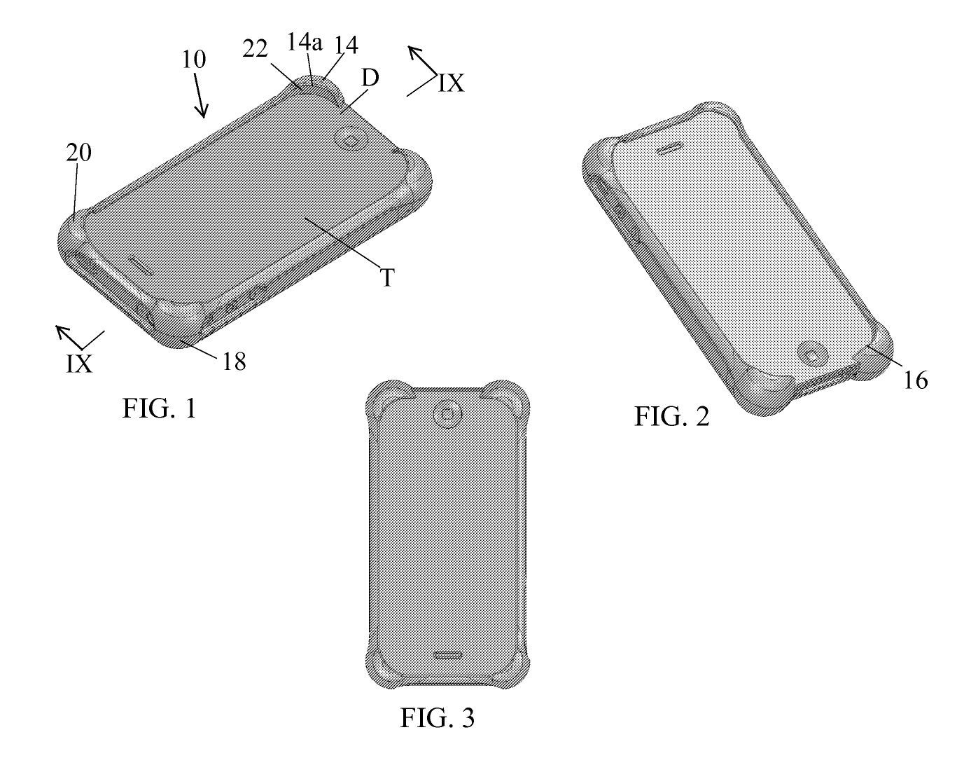

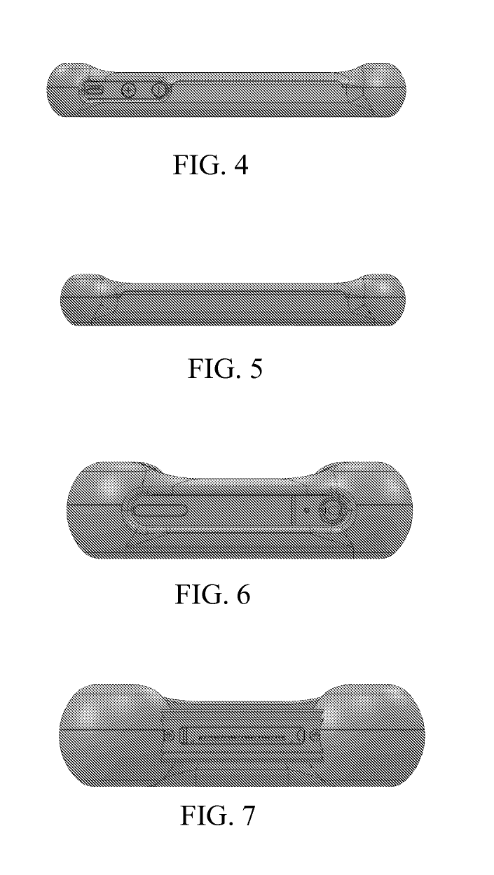

Referring to FIG. 1, the numeral 10 generally designates a cover for a handheld electronic device. In the illustrated embodiment, the handheld electronic device D comprises a cell phone and is illustrated with its touch screen display identified by the letter T. However, it should be understood that other types of cell phones may be used, and that the cover may be used on other types of handheld devices, such as a pad or a tablet or other electronic devices that emit sound. As will be more fully described below, cover 10 is adapted to harness the sound waves from one or more speakers or other sound emitting component or components on the handheld device and redirect the sound waves to a location or locations remote from the speaker (or sound emitting device) to reduce the “tinny sound” of the sound waves and provide a more pleasing sound for the user of the device. The tiny sound is referred to as a “partial phase cancellation caused by an echo being added to the primary source, typically at higher frequencies within typical users range of hearing.

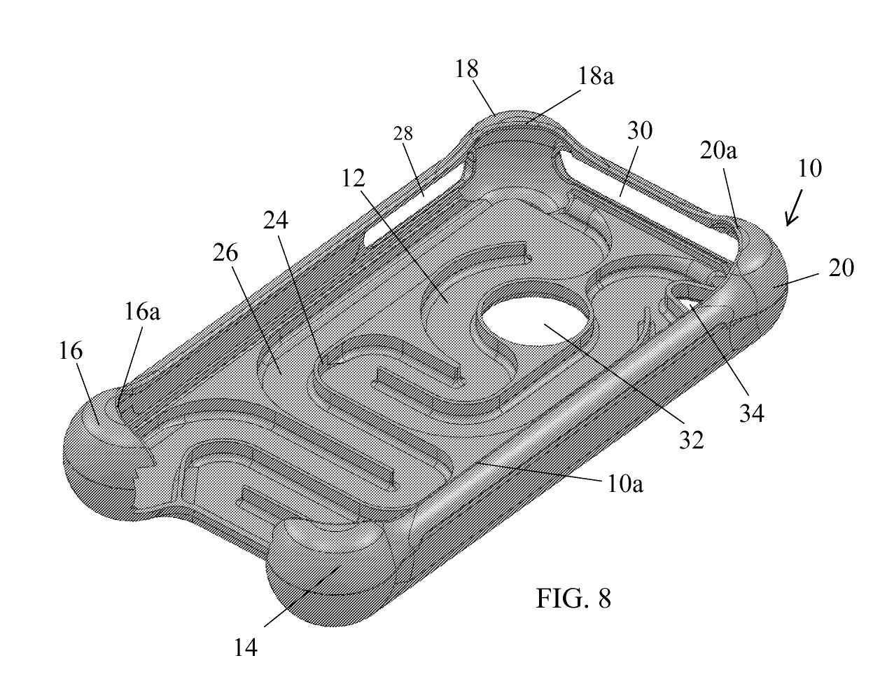

As best seen understood from FIGS. 1 and 8, cover 10 is adapted to cover at least a portion of the device and incorporates a channel that directs the sound waves emitted from at least one speaker or audio output component of the device to one or more locations remote from the speaker or output component. While hereinafter reference will be made to a “speaker”, it should be understood that the term “speaker” is used broadly and is intended to cover any component that emits audible sound waves for a handheld device to convey, for example, music sounds, sound effects, voice sounds or the like.

In the illustrated embodiment, channel 12 has a convoluted path that extends across the cover, for example, from one end of the cover to the other end of the cover. Further, channel 12 extends and is in communication with enlarged regions or pockets formed in the cover at the corners of the cover, which envelope the corners of the device. With the exception of pocket 14, each pocket includes a lip or edge that is spaced from the face of the handheld device, such as shown in FIG. 1, to allow the sound waves to be emitted for example at the corners of the handheld device around the outer perimeter of the device. This provides a more concentrated desired sound quality to the primary users as compared to what the same device sound source can be provided to the primary user without the aid of cover 10. Pocket 14 is adapted to enclose the device's speaker, and optionally seal against the front facing side of the handheld device around the speaker. In the illustrated embodiment, pocket 14 includes a downwardly depending wall 22 from its lip 14a that encloses the speaker that is located at that the corresponding corner of the device D. In this manner, a seal may be generated between the cover and the device around the sound source providing more direct concentrated sound impulse back through the channel to the other corners of the device and/or optionally to the leading edges of the front face of the device so that the sound is directed back toward the primary user from several different sources.

Referring again to FIG. 8, channel 12 may be formed from upwardly extending flanges 24 that extend up from the back wall 26 of cover 10 and form the convoluted channel that extends across the back wall of the cover. Optionally, the upwardly extending flanges 24 may include a sealing surface or gasket along their upper edges for sealing against the back side of the device to thereby create an airtight and sound duct that isolates the sound so that the sound can be channeled and redirected as noted above. For example, the sealing surface may be formed by the material forming the cover or attached to the cover by an adhesive, mechanically attached, or applied using a secondary molding process, such as by an injection molding. By sealing the channel against the back surface of the device, sound energy of the primary sound source speaker or speakers (mono or stereo) provides a more efficient manipulation and redirection of the finite sound energy available from the device. As noted, the channel when enclosed by the rearward facing side of the device forms a sound duct to create an initial sound source located at or near the device sound source but then redirects the sound energy along and adjacent the back of the device creating one or more secondary sound source locations in and along the entire perimeter of the front leading edge screen perimeter of the device. Further, as the primary sound energy is travels throughout the ducting system, there occurs an attenuation of the sound due to multiple factors.

One primary factor in the attenuation of the internally ducted sound energy is the increase in distance travelled between the primary sound source and its distance of travel through a medium (in this case atmospheric pressured air). Because of the attenuation of sound energy over a distance between the primary sound source and a secondary source distance, it is necessary to provide a feature that can compensate for and balance out an equal sound energy level to be measured at each sound source location along the sound ducting system the parameters that can be controlled include, for example, the variation and restriction of the ducting cross section and the end orifice size at the primary and/or second, third, fourth or nth sound port. Restriction in duct cross section and/or sound port opening size will allow to balance resulting sound levels at all ports (sound ports) regardless of the level of internal sound energy within adjacent ducting. One goal is to create a balanced and even sound level along the entire screen perimeter.

The sound quality can also be manipulated running a series of sound ports coming from the ducting system. By maximizing the length of travel of the sound wave from initial primary source sound port to the last sound port within the ducting system series, and providing a single additional or multiple sound ports at equal and varying lengths along the ducting system; it is possible to have the initial sound wave being delayed from sound port to adjacent sound port as a function of distance of travel from sound port to sound port and the speed of sound. For example, 24″ between initial and final sound port can create and approximate a 2 millisecond delay in the same sound energy being transmitted to the device users hearing. This can serve to reinforce the primary sound quality and provide a richer and fuller listening experience for the device user without any manipulation of the device or its electronics.

To accommodate the buttons, various ports, and other devices, such as cameras, on the handheld device, cover 10 may incorporate several access openings. For example, cover 10 may include an opening 28 along its lateral side edge to accommodate control buttons, an opening 30 along its transverse side to, accommodate a power cord receptor, and, for example, an opening 32 in its back wall 26 to reveal the phone logo. Additional openings may be provided for example opening 34 and its back wall 26 to accommodate for example a camera.

Cover 10 may be formed from a variety of different materials including a rigid material, a semi-rigid material and a flexible material. For example, suitable materials may include metal, plastics, an elastomeric material or combination thereof, and, further, may be molded, stamped out or formed using a conventional process. Furthermore, the channel may be created by an insert that is separately formed and then inserted into the cover and either adhered to the cover, for example, by an adhesive, welding, or the like, or may be mechanically attached with an optional seal interface between the insert and the cover back wall.

Referring to FIG. 8, as previously noted, the lips or edges 16a, 18a, and 20a of the pocketed areas may be spaced from the front-facing side of the device. Optionally, the remaining inner perimeter of the cover may be sealed against the front facing side, for example the touch screen display T so that the sound is emitted only from discrete locations, as previously noted, namely at pockets 16, 18, and 20 (between the cover and the device). The inner perimeter 10a of cover may be formed to create the seal between the pockets or may be sealed by a secondary material formed or applied to the cover.

Although cover 10 is illustrated as extending around and covering only a portion of the devices outer perimeter, cover 10 may be adapted to extend around the full outer perimeter of the device as well but with access opening where needed. Further, as will be more fully described below, the cover may be adapted to extend only across a portion of the back side of the handheld device.

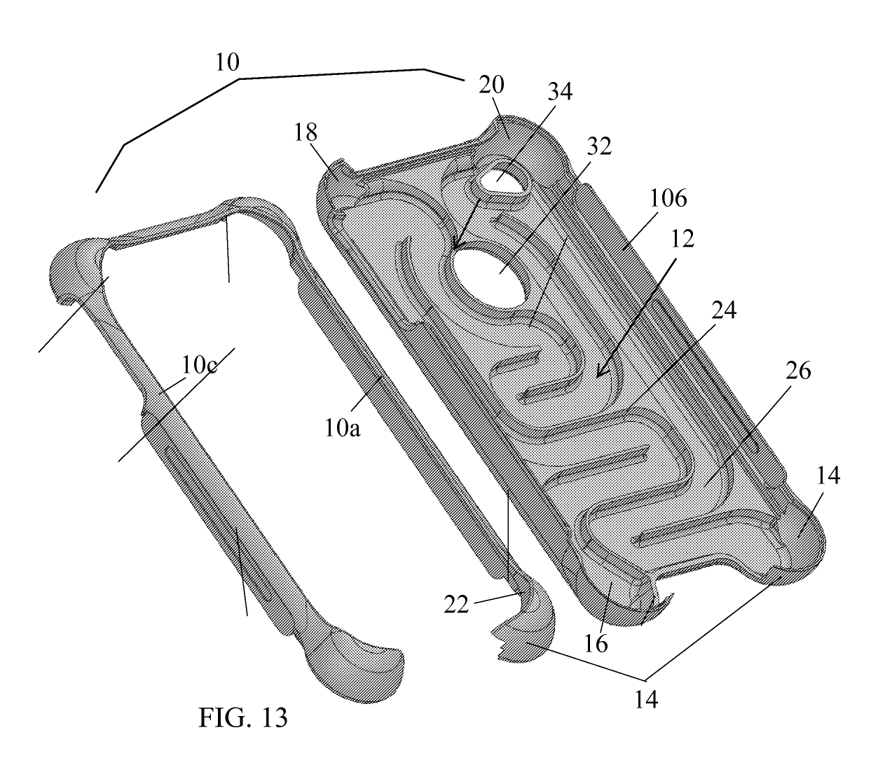

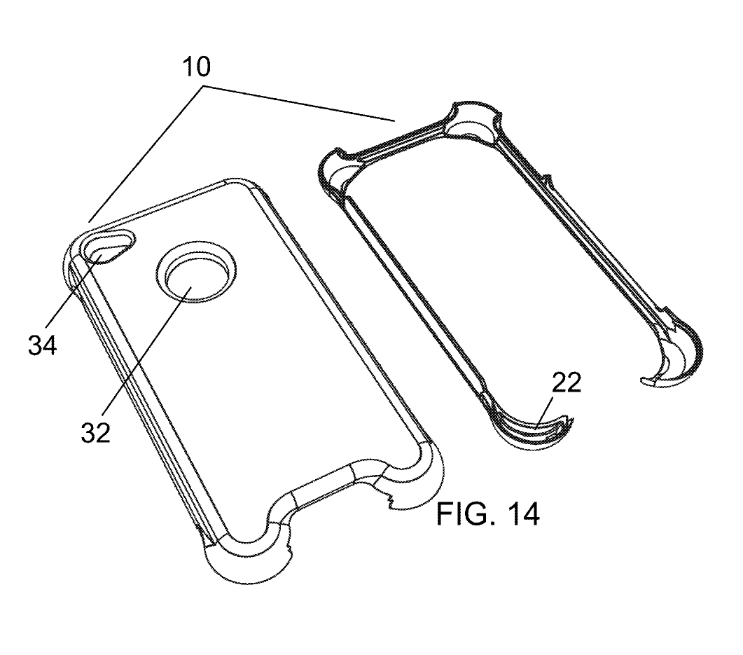

Referring again to FIGS. 13 and 14, as previously noted, cover 10 may be formed from two components that are snap-fit together or may be permanently joined together, such as by welding or by way of an adhesive. For example, the base 10b of the cover 10 may provide the cover back wall 26 and the channel 12 and, further, form part of the pockets 14, 16, 18, and 20. The other portion of the pockets may be formed by the top half 10c of cover 10, which also forms the inner perimeter 10a of the cover 10.

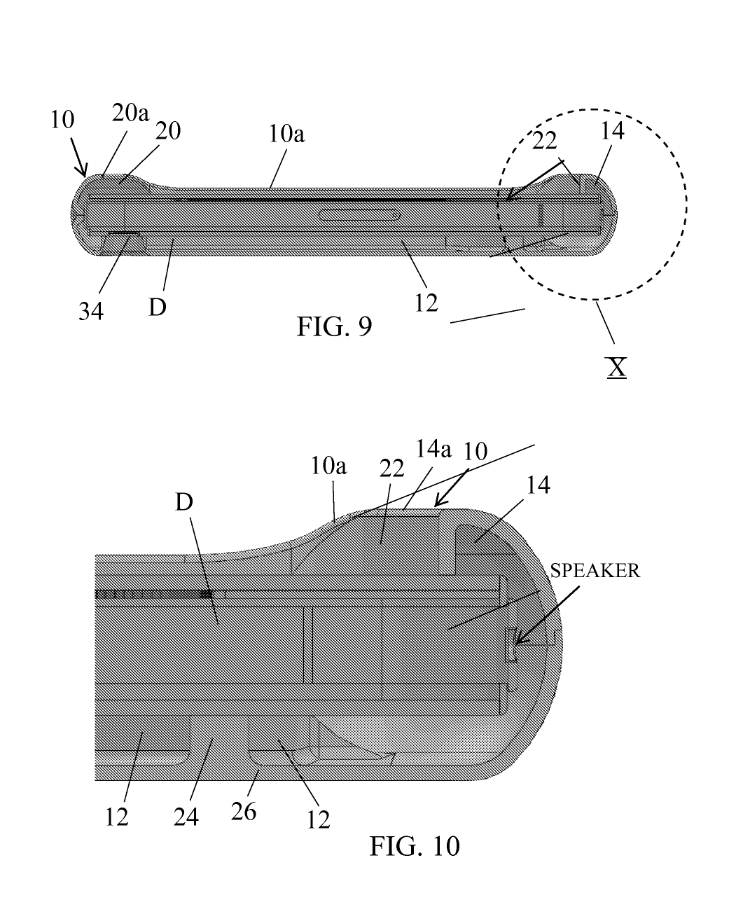

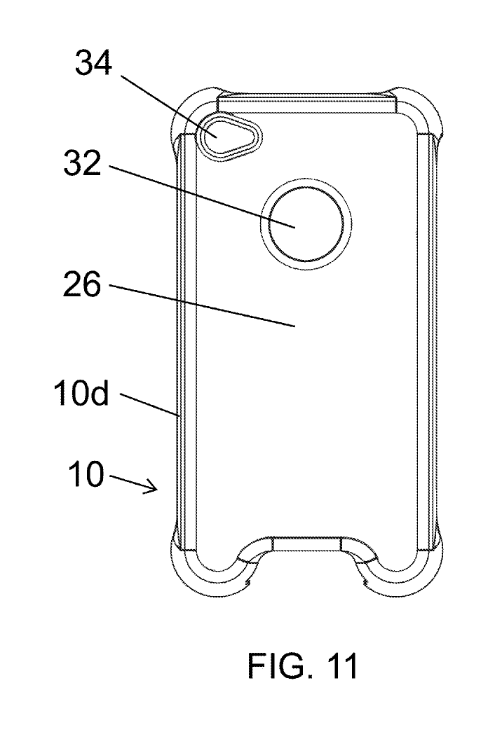

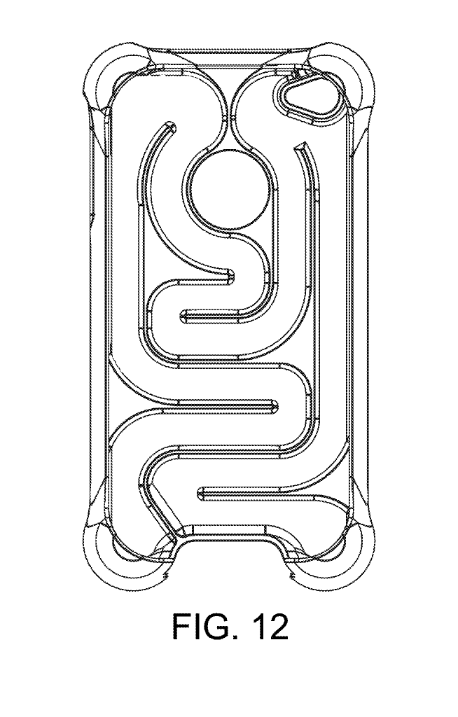

As best understood from FIGS. 9 and 10, in addition to pockets 14, 16, 18, and 20, which provide a space between the cover and the device, cover 10 forms a space between the cover and the back side of the device at the respective pockets as well as along the perimeter of the device, for example, by way of channel 10d, shown on FIG. 11. Therefore, in addition to providing a sound duct, cover 10 also protects device D from impact by providing a space between the cover and the device at strategic locations around the device, which allows the cover to absorb energy should the device be dropped or impacted at least where the device is protected by the cover.

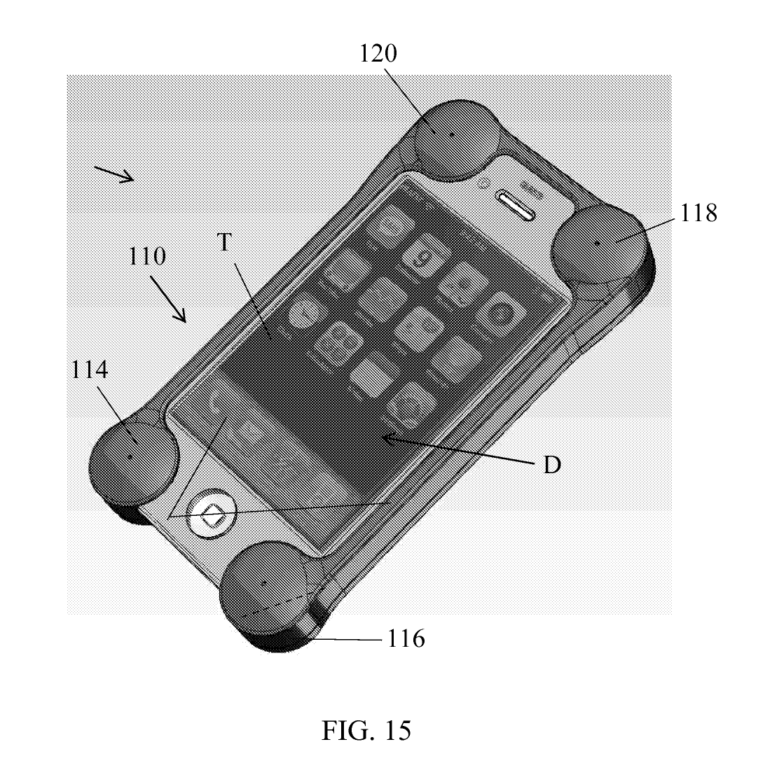

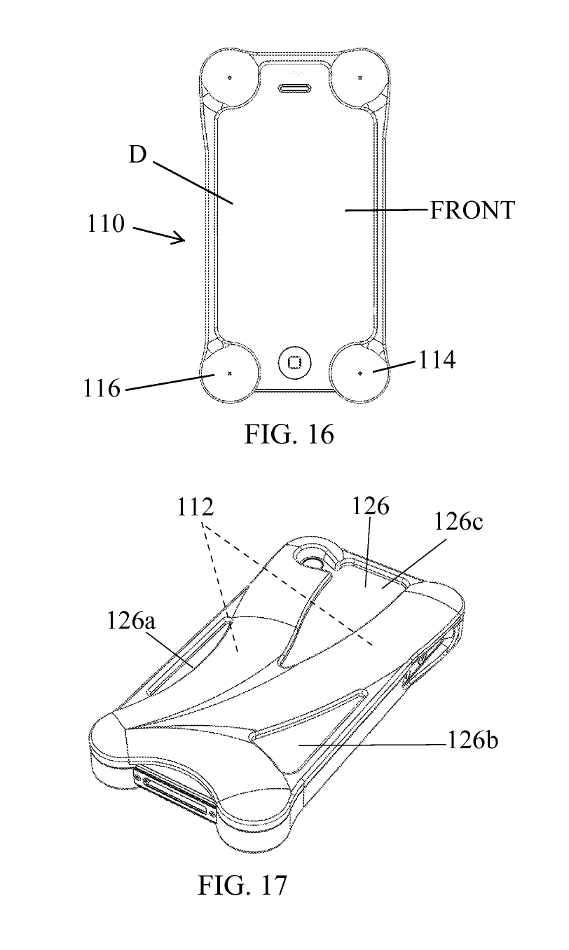

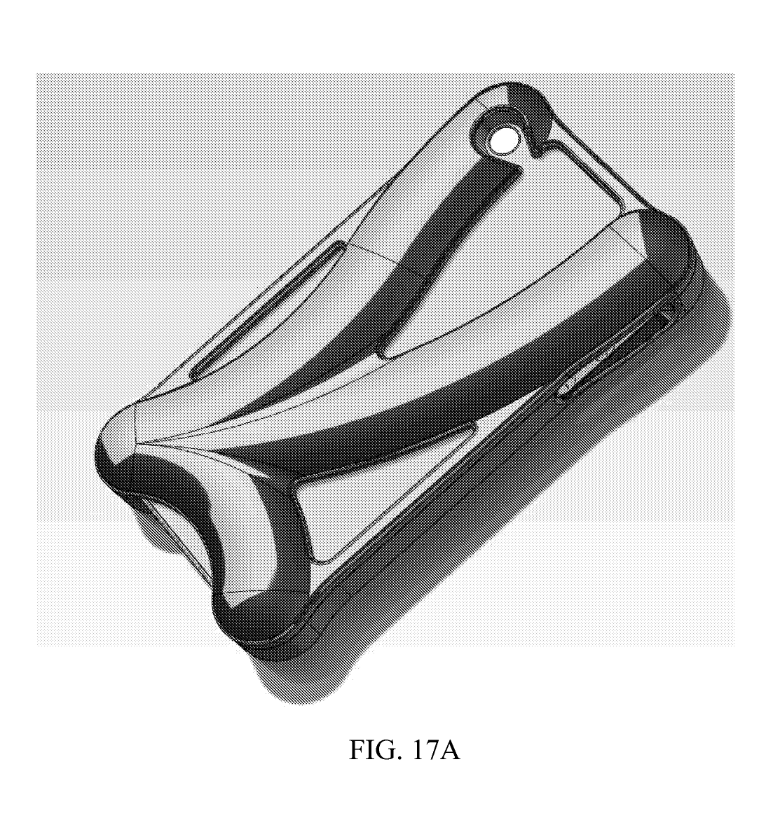

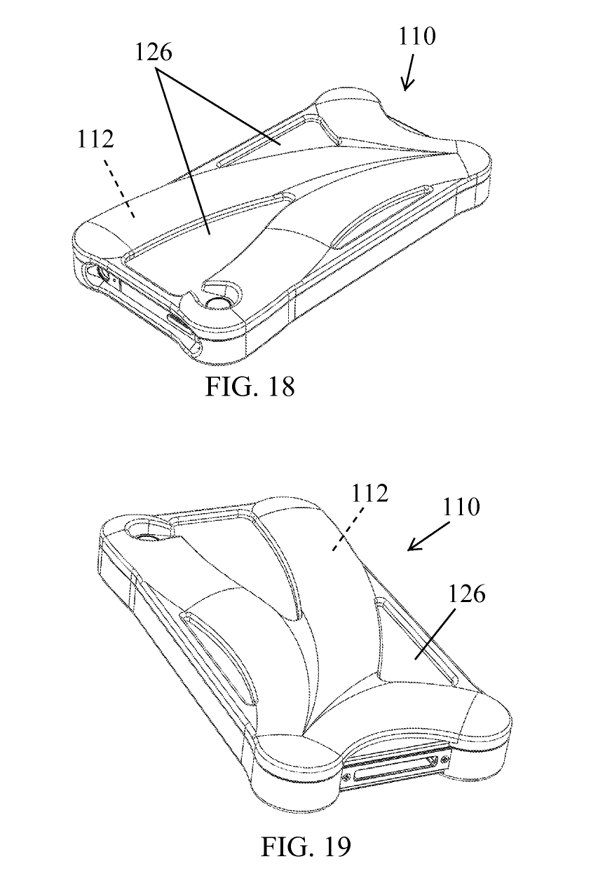

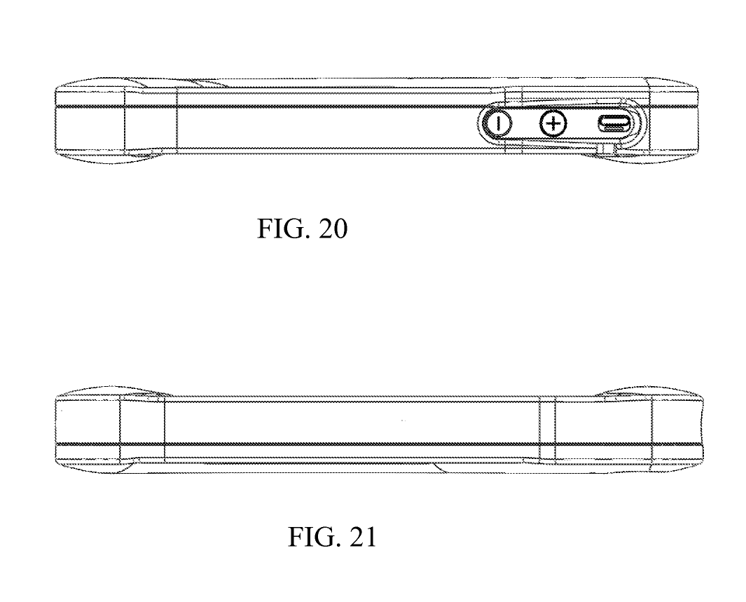

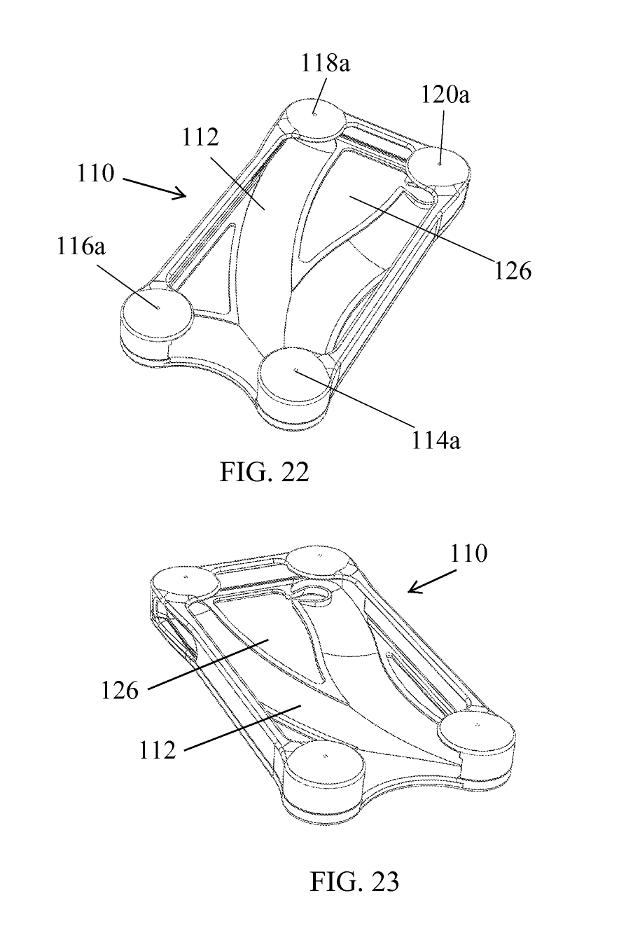

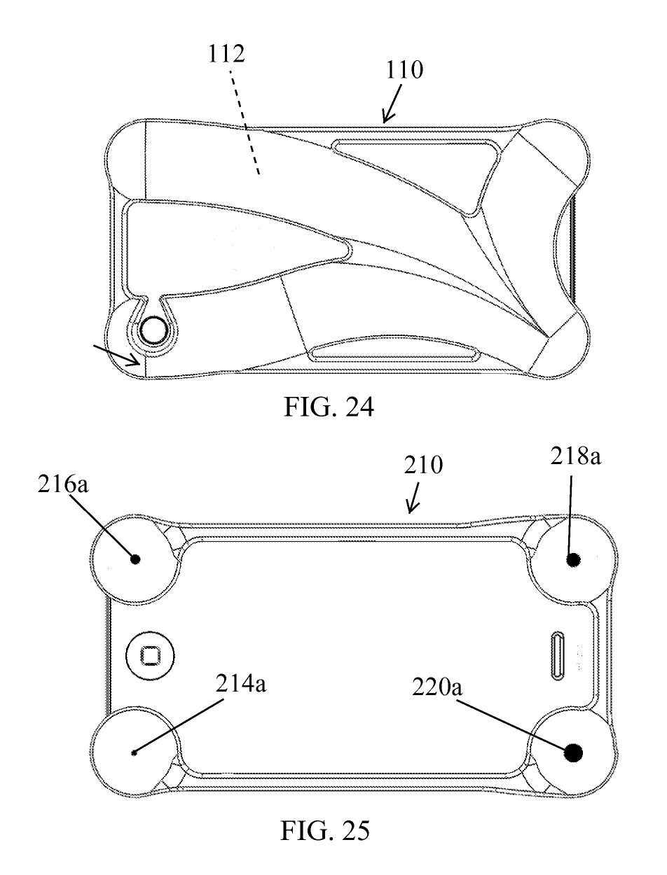

Referring to FIG. 15, the numeral 110 designates another embodiment of the present invention. Cover 110 similarly incorporates a channel 112 in its back wall 126 that forms a sound duct when the cover is mounted on a device. Cover 110 incorporates cylindrical-shaped pockets 114, 116, 118, and 120 at each of its corners to extend over one or more speakers and, further, to form protection for the device.

In the illustrated embodiment, channel 112 projects outwardly from back wall 126 to form recessed areas 126a, 126b, and 126c, whose perimeters may then form the sealing surfaces for sealing against the back side of the device. These recessed areas may also include openings.

Optionally, each pocket 114, 116, 118, and 120 may include openings 114a, 116a, 118a, and 120a to provide the outlet ports to emit the channeled sound, which are spaced around the perimeter of the device.

Referring to FIG. 25, the numeral 210 generally designates another embodiment of a cover of the present invention. Cover 210 is similar to cover 110 but includes openings 214a, 216a, 218a, and 220a with different diameters to thereby adjust the audio output at various locations around the device.

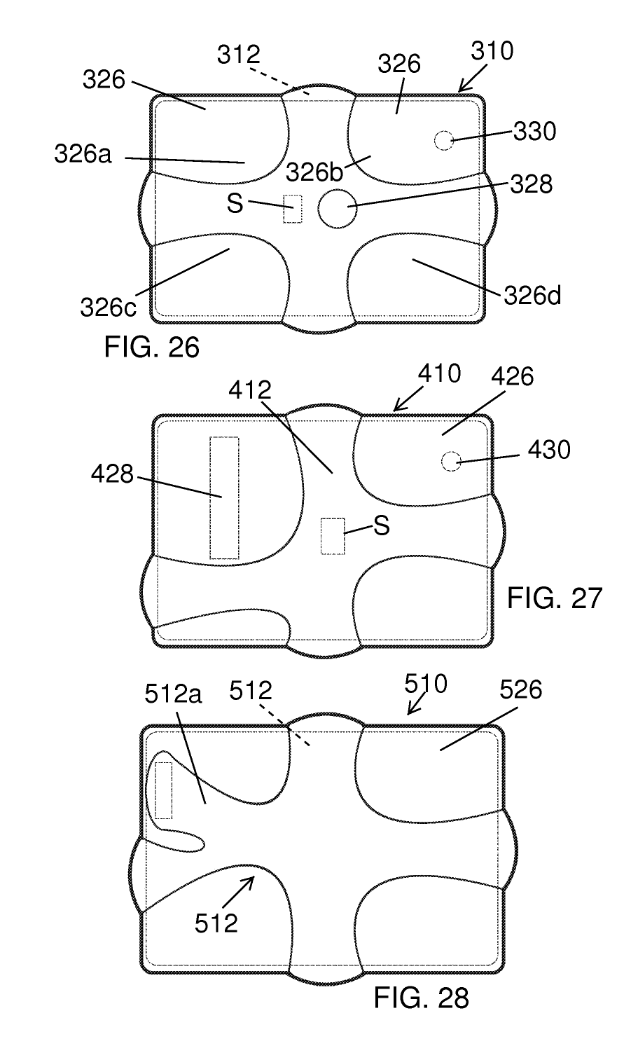

Referring to FIGS. 26-28, the numerals 310, 410, and 510 generally designate additional embodiments of a cover of the present invention. Covers 310, 410, and 510 are configured to cover larger hand-held electronic devices, such as (electronic tablets) pads. Each cover similarly incorporates channels 312, 412, 512 that form sound ducts between the back side of the device and the cover back wall 326, 426, and 526. Like the channels in the previous covers, the channels are configured to channel sound waves from one or more speakers of the device to one or more locations around the perimeter of the front facing side of the device.

For example cover 312 includes a back cover with a cross-shaped channel 312 with arms that extend from the central portion of the back wall to medial portions of each side of the device. Each arm of the channel is then is in communication with ports that are located on the front facing side of the device, which may be formed from similar structures described in reference to the previous embodiments. Further, channel 312 may similarly project outwardly from the cover base wall 326. The recessed regions 326a, 326b, 326c, 326d adjacent channel 312 may be solid or may have openings (e.g. 330 for a camera). Similarly, one or more openings 328 may be provided in channel 312, for example, to accommodate a logo or a device.

Cover 410 is similar to cover 310 but with an asymmetrical cross-shape channel where the ports are offset along at least one side of the device. Again, cover 410 may incorporate a plurality of openings (e.g. 428, 430) to accommodate, for example, a phone stand leg or a camera.

Cover 510 also incorporates an asymmetrical cross-shaped channel 512 but with an extra leg 512a to extend over a speaker located at the back of the device (but toward the perimeter at one of the corners of the device).

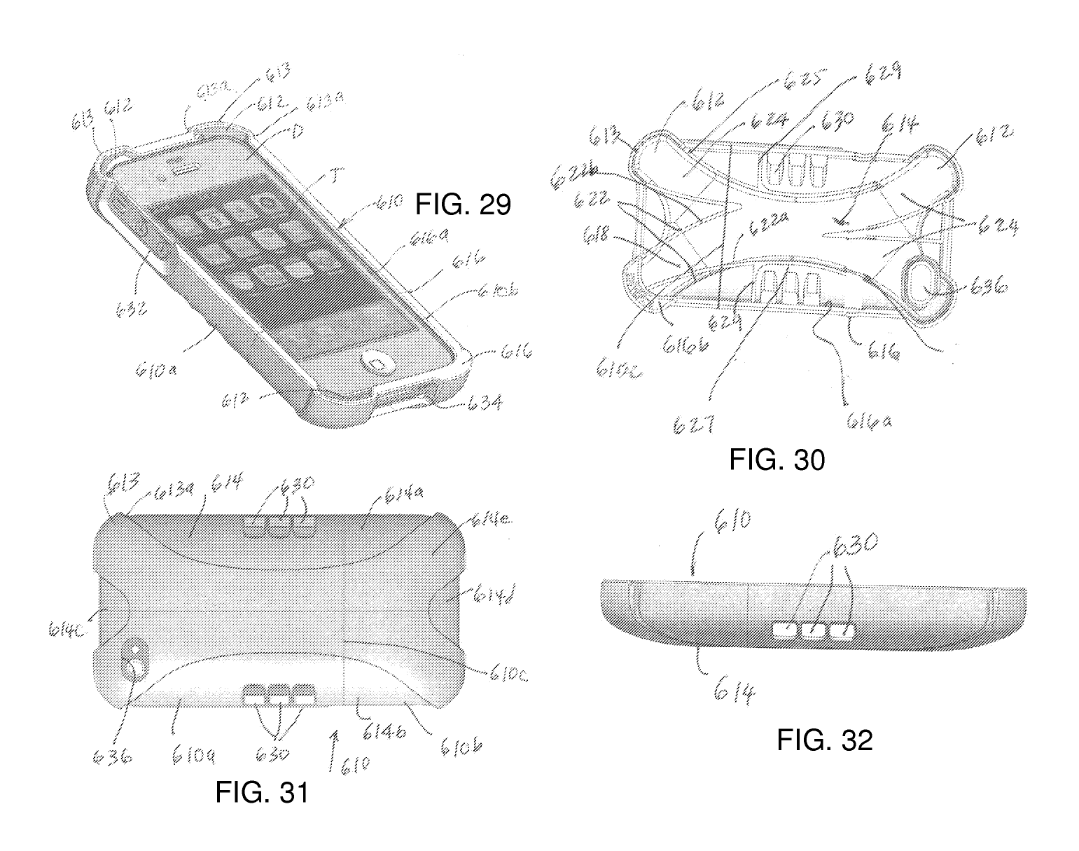

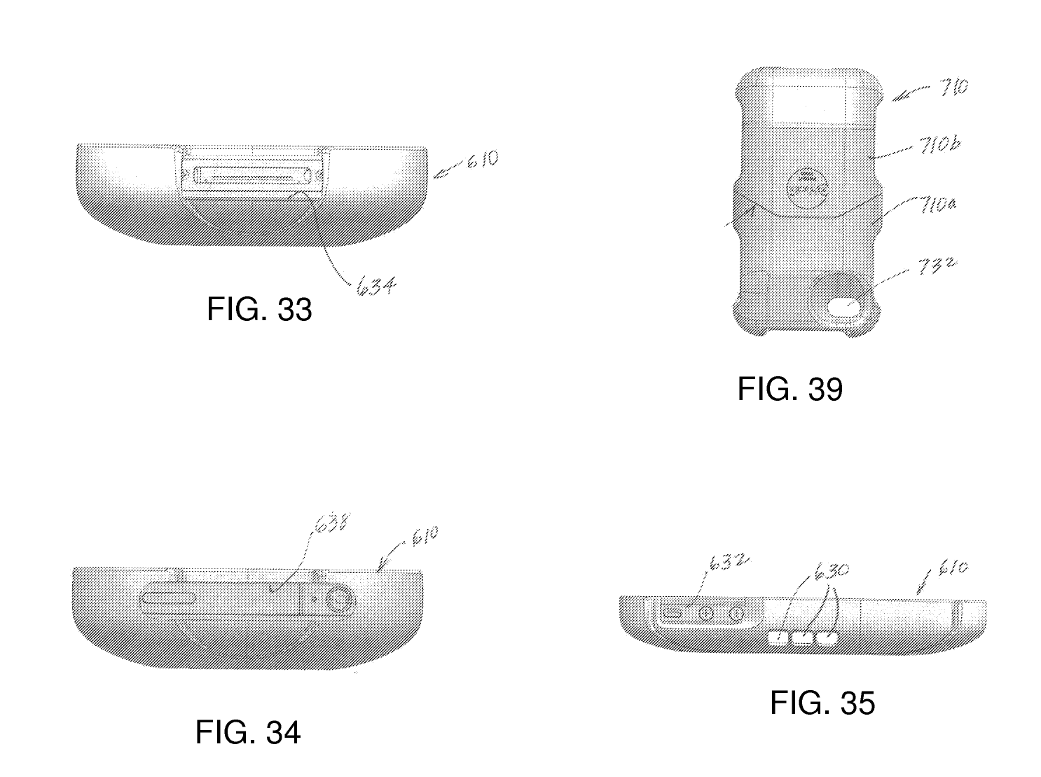

Referring to FIG. 29, the number 610 generally designates another embodiment of a cover for a handheld electronic device, which is configured to harness the sound emitted from one or more the speakers of the device and, further, to direct the sound to one or more locations remote from the speaker. Additionally, as will be more fully described below, cover 610 may also be adapted to absorb some of the sound frequencies, for example some of the high frequency sounds, to reduce the tinny sound and provide a more pleasing sound for the user of the device.

As best understood from the FIGS. 29 and 30, cover 610 is configured to cover at least a portion of the device and further form outlet openings or ports at two or more selected, discrete locations around the device through which the sound from the speaker is directed. For example, in the illustrated embodiment, a first group of outlet openings 612 is located at the corners of the device D facing the user. However, it should be understood that the outlet openings may be formed at different locations around the device, depending on the device configuration and/or the preference of sound direction. With the outlet openings oriented at the front face of the device, cover 610 directs the sound waves from the speaker in the direction of the user and, further, as will more fully described below, in a manner that gives the perception of increased volume, but optionally without the use of power.

In the illustrated embodiment, cover 610 includes a cover body with a base wall 614, which when mounted to the device is spaced from the device body, and an upwardly extending perimeter side wall 616 which together form a plenum space between the device body and the cover. Further, the cover may be configured and arranged to seal against the device body around the speaker (or speakers) so that essentially all of the potential audible sound energy developed by the speaker (or speakers) of the device can be harnessed and concentrated by the cover so that essentially all of the sounds wave can be directed to the listener's ear.

Referring again to FIG. 29, side wall 616 includes a downwardly extending lip 616a that optionally seals against the device body along the front facing sides and ends of the device but which then diverges away from the device body over several discrete regions to form the outlet openings or ports or spaces 612 between the cover and the device body and further to form the outlet chambers 613 around openings 612, which direct the sound harnessed in the plenum space out from cover 610. As noted, in the illustrated embodiment, these outlet chambers are formed at the three corners of the device and face the user so that sounds harnessed in the plenum space can travel from the chambers in the direction of the user.

In the illustrated embodiment, side wall 616 includes flared regions that form chambers 613 at three corners of the device, which configuration creates gripping surfaces 613a around the cover, which may be especially desirable when using the device as a gaming device. The side wall 616 also includes an extended flange or wall 616b over the fourth corner to cover and optionally seal around the speaker and direct substantially all the sound from the speaker into to the plenum space formed between the base wall of the cover and the device body.

Referring to FIG. 30, to redirect the sound from the speaker to the plenum space and then to the corners of the device, cover 610 incorporates at least one channel 618 which is in communication with the speaker on one end and in communication with a chamber 620, which forms part of the plenum space, at its distal end. The chamber 620 may be directly in communication with each of the outlet chambers 613 or may be in communication with one or more outlet chambers 613 by way of additional channels described below. Channel 618 is formed by upwardly standing flanges or side walls 622, which are optionally integrally formed with base wall 614 of cover 610, such as by molding or by being post applied using an adhesive. Further, upwardly standing side walls 622 are sized such that the upper distal edge of the respective side wall 622 extends to and optionally seals against the back of the device body (when the cover is mounted to the device) so that all of the sound waves emitted from the speaker are directed along the channel. Thus substantially all of the sounds waves emitted from the speaker will travel up channel 618 from its proximal end (adjacent to the speaker) to its distal end adjacent central chamber 620 and thereafter travel to outlet chambers 613.

Optionally, channel 618 may be configured to operate like an internalized megaphone within the handheld device case or within the handheld device itself (as described more fully below). For example, walls 622 may be a tapered so that channel 618 concentrates and naturally amplifies the sounds waves and thus create a more centrally directed and naturally amplified sound energy to the user. Optionally base wall 614 of cover may be flat or may have a slope, such as shown in FIG. 32, to thereby form a generally cone or horn shaped channel. In addition, walls 622 may be curved to reduce interference with the sound waves.

Referring again to FIG. 30, cover 610 optionally includes additional secondary channels 624 which provide communication between central chamber 620 and outlet chambers 613 to further enhance the transmission of the sound waves from the central chamber 620 to the outlet chambers 613. Cover 610 may also incorporate openings or ports 630 in base wall 614 to allow the sound waves to emanate from the back of the cover 610, which may also help with reducing echoes, which will be more fully described below. To direct the sound waves to openings 630, cover 610 may incorporate another set of secondary channels or may locate them at the end of channels 624, such as shown in FIG. 30, which can create a coffered space. Additionally channels 624 may also be tapered such their respective side walls or flanges 625 diverge and concentrate the sound waves as they travel from the central chamber 620 to chambers 613 and optional openings 630. Similarly, back wall 614 may taper from the proximal end of the respective channels 624 to the distal end of the respective channels to thereby form generally cone or horn shaped channels to further enhance the concentration of the sound waves.

In the illustrated embodiment, channels 624 are formed upwardly standing walls 625, 627, which are also optionally integrally formed with base wall 614 of cover 610 (such as by molding, stamping etc. (see below for various methods for forming the cover) or by being post applied using an adhesive or mechanical attachment) and further are sized such that the upper distal edge of the respective side walls 625 extends to and optionally seals against the back of the device body (when the cover is mounted to the device). To direct the some of the sound waves to openings 630, walls 627 terminate before reaching outlet openings 612, which forms a coffered space and directs some of the sound waves to openings 630 and reduces, if not eliminates, reflections or echoes that may occur. The terminal end of that channel is then optionally closed by another upstanding wall 629, which is also size to extend to and optionally seal against the back of the device.

In addition, similar to walls 622, walls 625 and 627 are curved to create a smooth pathway for the sound waves. Further, wall 622a transitions into wall 627 forming a continuous smooth curve. Similarly, the curve of the opposed wall 622b projects onto and aligns with the curve of wall 625, which again creates a smooth pathway for the sound waves. With this configuration, it has been found that echoes are significantly reduced if not eliminated and further the sound transmission is more efficient so the perceived volume of the sound waves as they exit the cover is noticeably increased in volume to the user.

As would be understood, therefore, all the walls forming the respective channels extend up to and optionally contact the rearward facing surface of the device and, further, optionally thereby seal the respective channels to the back side of the device so that essentially all the sound waves which are emitted from the speaker are directed through the respective channels to the outlet openings. For example, the height of the respective wall 622, 625, 627, and 629 may range from about 1 mm to 15 mm within a smartphone assembly, optionally from 2 mm to 50 mm within a tablet assembly. Furthermore, the thickness of the respective walls may vary in a range from about 0.5 mm to 3 mm. The length of the channels also may vary. For example, the length of the respective channels 618 and 624 may range from about 10 mm to 175 mm within a smartphone assembly, optionally from about 10 mm to 400 mm within a tablet assembly. Additionally, when base wall 614 is sloped, the height of the respective walls may vary to follow the taper of the back wall and therefore may range about 2 mm to 15 mm at their shortest height to about 5 mm to 30 mm at their tallest height within a smartphone assembly, which typically corresponds to their locations adjacent base central chamber 620. Further, the angle of taper on the channels may vary. For example, the angle of taper may vary from about 0.5 to 45 degrees.

Referring again to FIG. 30, each side of the walls forming the channels has a smooth transition with the base wall to avoid any sharp angles, which could distort the sound waves. Similarly, the walls of adjacent channels may be joined with smooth transitions, again to avoid any sharp angles and minimize sound distortion.

Depending on the particular device, cover 610 may also include various access openings 632, 634, 636, and 638 to provide access to the controls of the phone, ports and further not to interfere with a camera of the device. In each case, the cover extends to and optionally seals against the device body around each access opening to minimize or prevent sound leakage.

Depending on the material forming cover 610 (see below), cover 610 may have a split construction with an upper half 610a and a lower half 610b which couple together by way of a friction fit or snap fit connection. For example, lower half 610b may include a flange that extends into upper half 610a and then frictionally engages the inwardly facing surface of the lower end of upper cover half 610a. While the term “half” is used, it is used loosely to mean that the cover has two parts. It should be understood that the location of the split 610c is not necessarily in the middle and, therefore, each half of the housing is necessarily not of equal size.

Similarly, the cover may be formed out of a semi-flexible or flexible material that will allow the smartphone or tablet to be placed inside of the case by way of stretching and flexing the perimeter of the case around the perimeter of the smartphone/tablet, and creating a secure post-stressed tensioned fit between the case and smartphone/tablet.

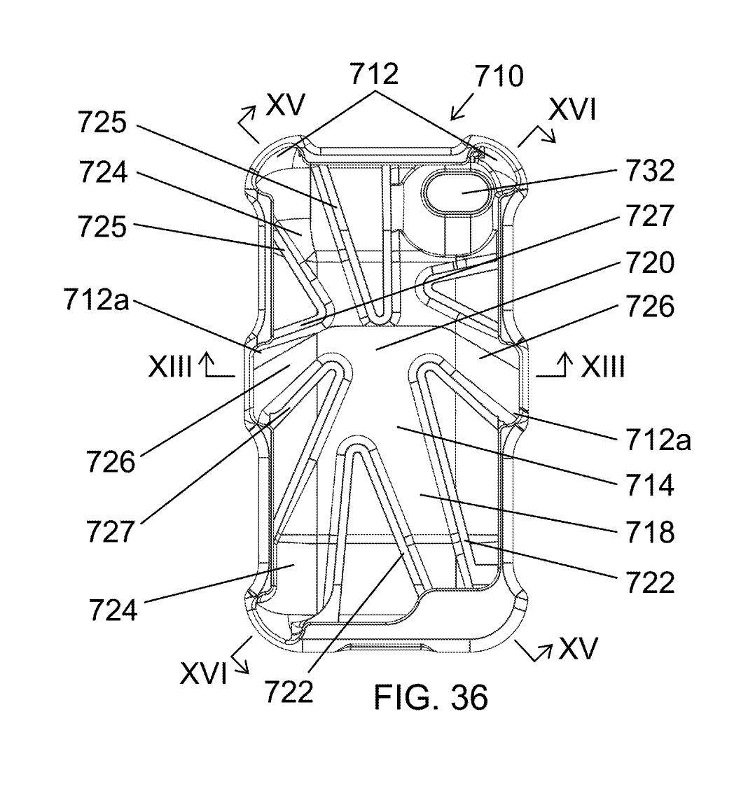

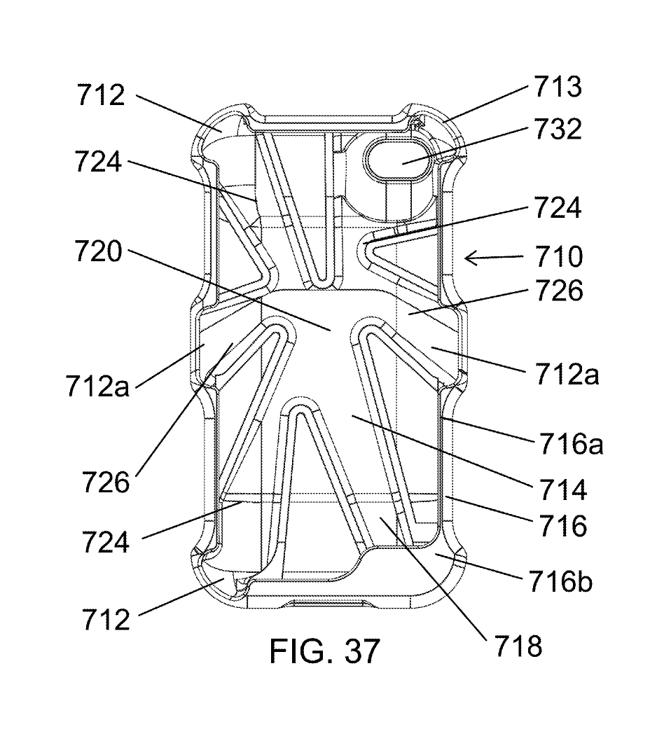

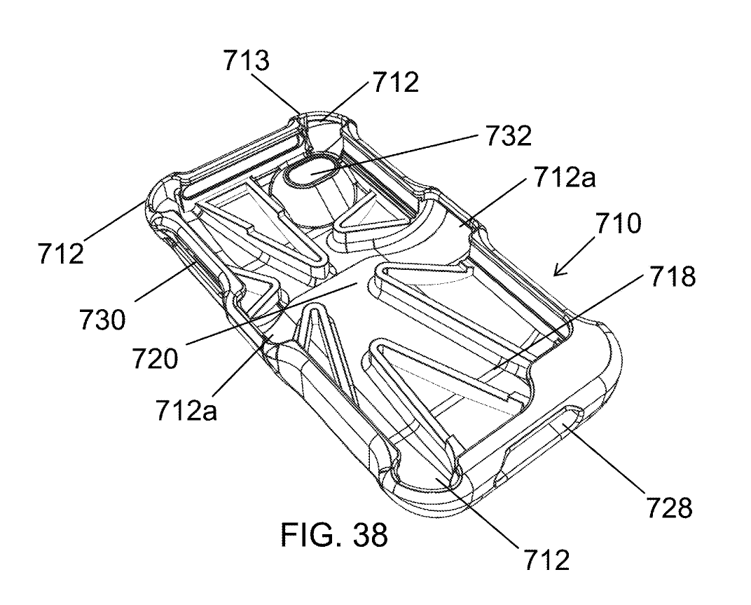

Referring to FIG. 36, the numeral 710 generally designates another embodiment of a cover of the present invention. Cover 10 is similar to cover 610 and includes a plurality of outlet openings or ports 712 and outlet chambers 713 formed at three of the corners of the device for directing sound outwardly from the face of the device. Cover 712 further includes two side chambers 713a, which form additional outlet openings or ports, located at the front face of the device along the sides of the device, which are generally located midway along the length of the sides of the device and which similarly direct sound outwardly from the face of the device.

In a similar manner to the first embodiment, cover 710 includes a back wall 714 with one or more channels 718 that capture and direct the sound waves from the speaker (which is also located in the lower right hand corner of the device) to a central chamber 720, which in turn is in communication with a plurality of channels 724 and 726 for directing the sound waves to the respective forwardly facing chambers 713 and 712a. The shape of chambers 713 and 712a also provide pronounced griping surfaces, which are formed by the transition regions of the cover's side wall adjacent chambers 713 and 712a.

Channel 718, 724 and 726 are also similarly formed by upstanding walls 722, 725, and 727, which extend to and optionally seal against the device body. In a similar manner the respective walls of the channels diverge and are tapered to concentrate the sound waves emitted from the speaker(s) so the volume of sound emitted from the outlet chambers of the cover appears to be greater than the sound from the device without the cover. Again, cover 710 incorporate several openings 728, 730, and 732 to provide access to the ports and controls of the phone, as well as the camera, which are optionally sealed to the device body around the respective accessory. Further, cover 710 may also incorporate a split construction.

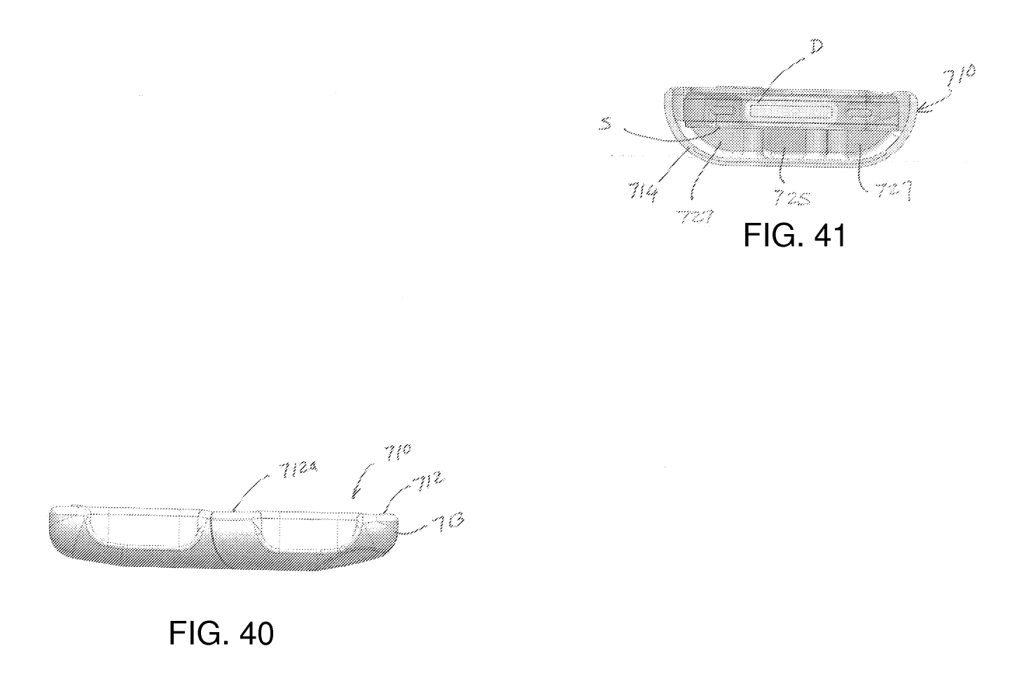

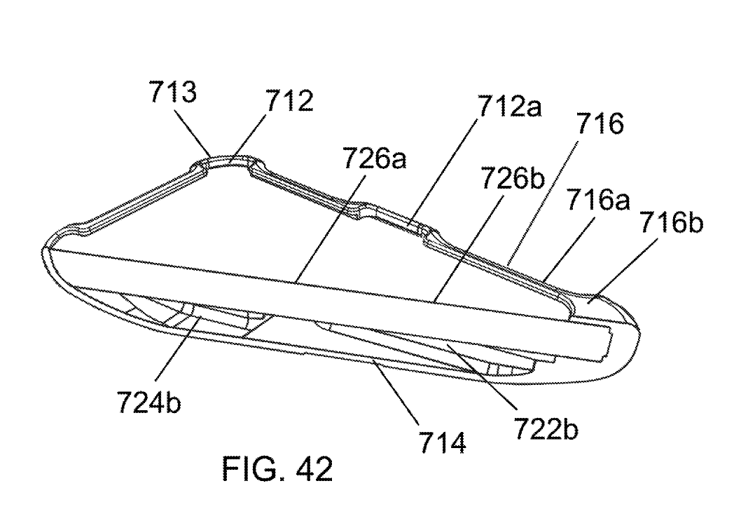

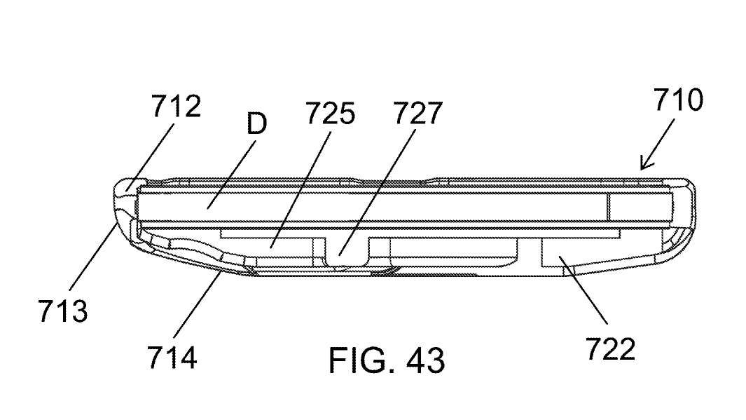

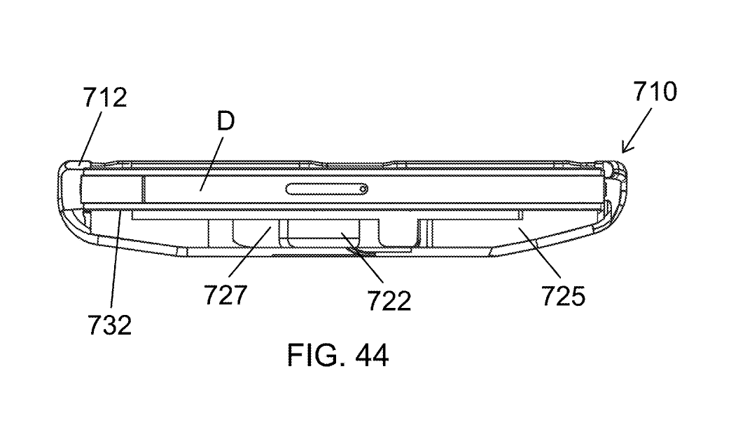

Referring to FIGS. 41-44, and as noted in reference to cover 610, all the walls forming the respective channels of cover 710 extend up to and contact the rearward facing surface of the device to thereby seal the respective channels to the back side of the device so that essentially all the sound waves which are emitted from the speaker are directed through the respective channels to the outlet chambers adjacent to the corners on the sides of the device. For examples of suitable dimensions reference is made to cover 610.

Additionally, cover 710 may be adapted to hold articles, such as credit cards, business cards to name a few. For example, some of the walls forming the channels may be shortened and then joined by a web to close the channels and also to form a shelf on which a card may be supported. Alternately, the walls may be simply shorted, with the card(s) then closing the channel. In the case of a cover with a split construction, one half of the cover may be mounted to the device, and then the card inserted into the space between the web (or upper edges of the walls) and the device, and then the other half can be slipped over the card and then inserted into or onto the other half of the cover. Alternately, the cover may incorporate an external pocket for receiving articles, such as credit cards, personal driver's license, and/or key.

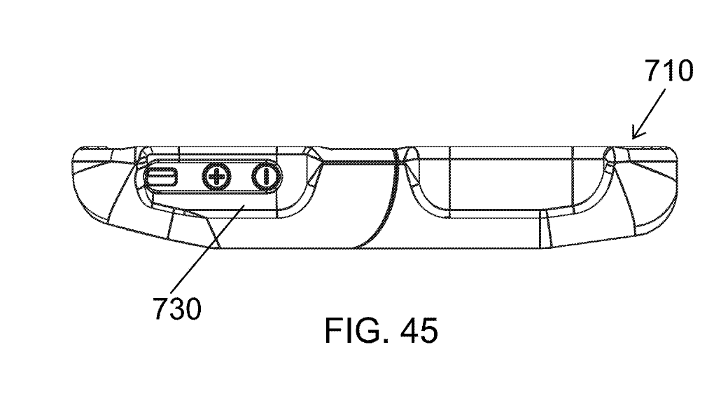

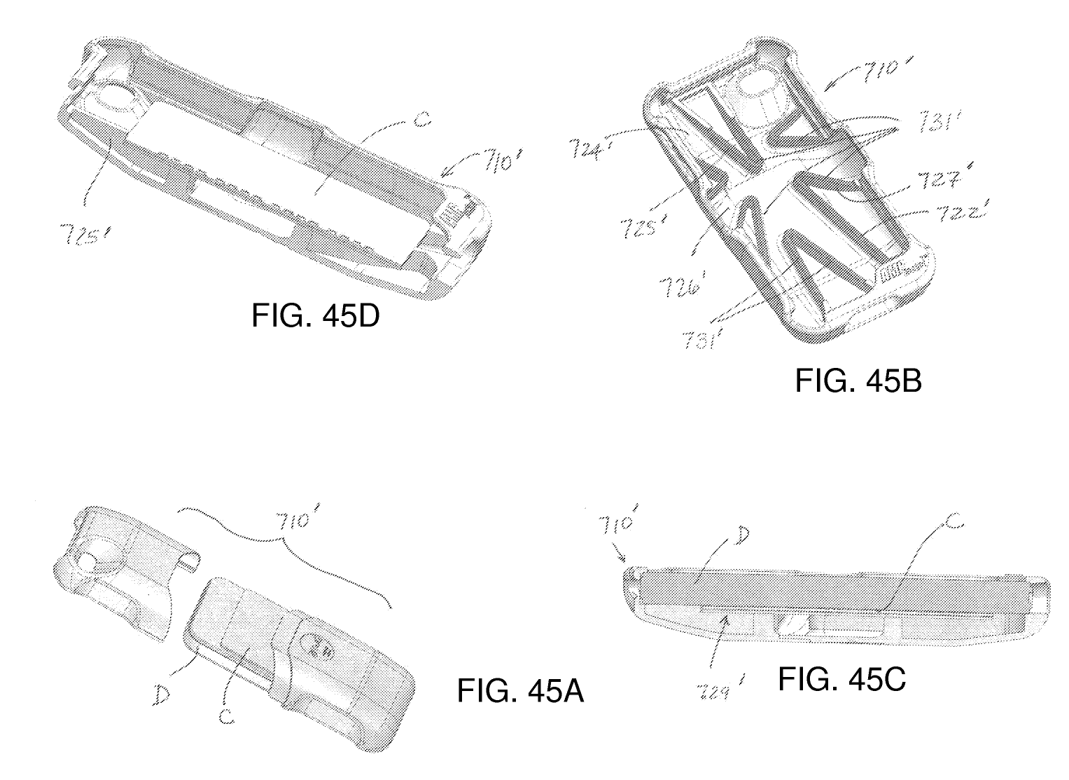

Referring to FIGS. 45A-45D, cover 710′, a slightly modified version of cover 710, includes a shelf 729′ formed by the upper edges 731′ of walls 725′ and 727′ of the respective channels 724′ and 726′, which are formed with regions of shorter height during the cover forming process or shorted after the cover forming process so as to create a recessed shelf for receiving a credit card C. In this manner, when cover 710′ is mounted to a device D, the credit card will be held between the cover and the device but in a manner not to interfere with the sound wave harnessing and concentration described above.

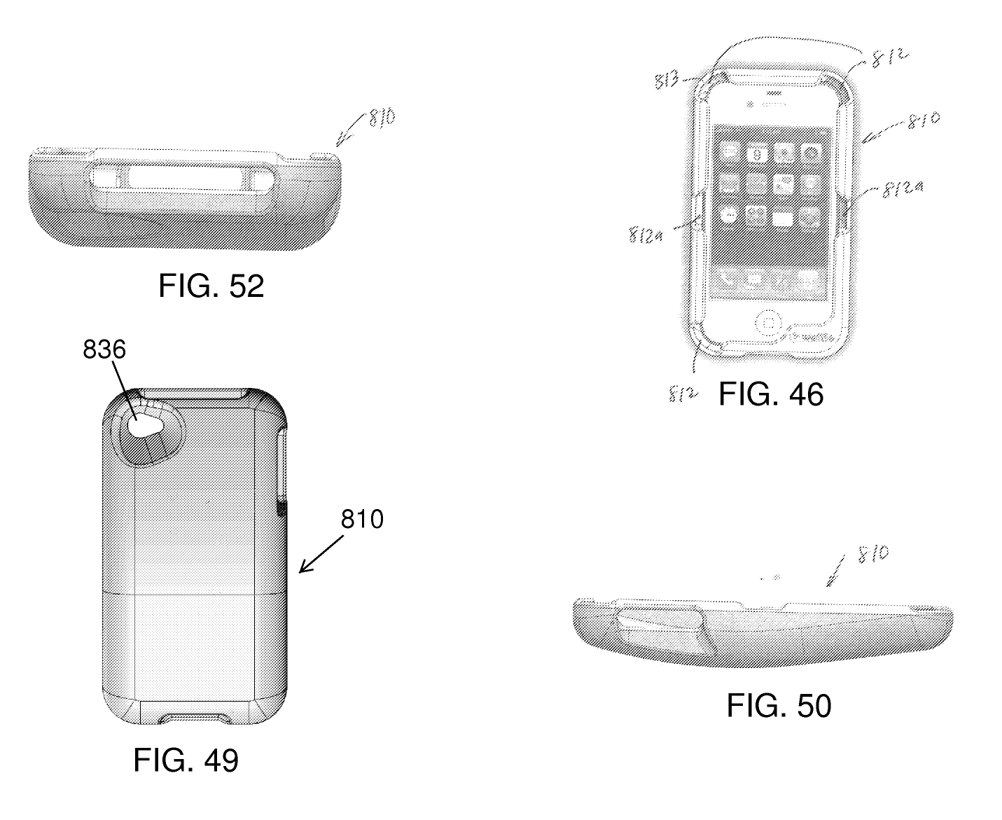

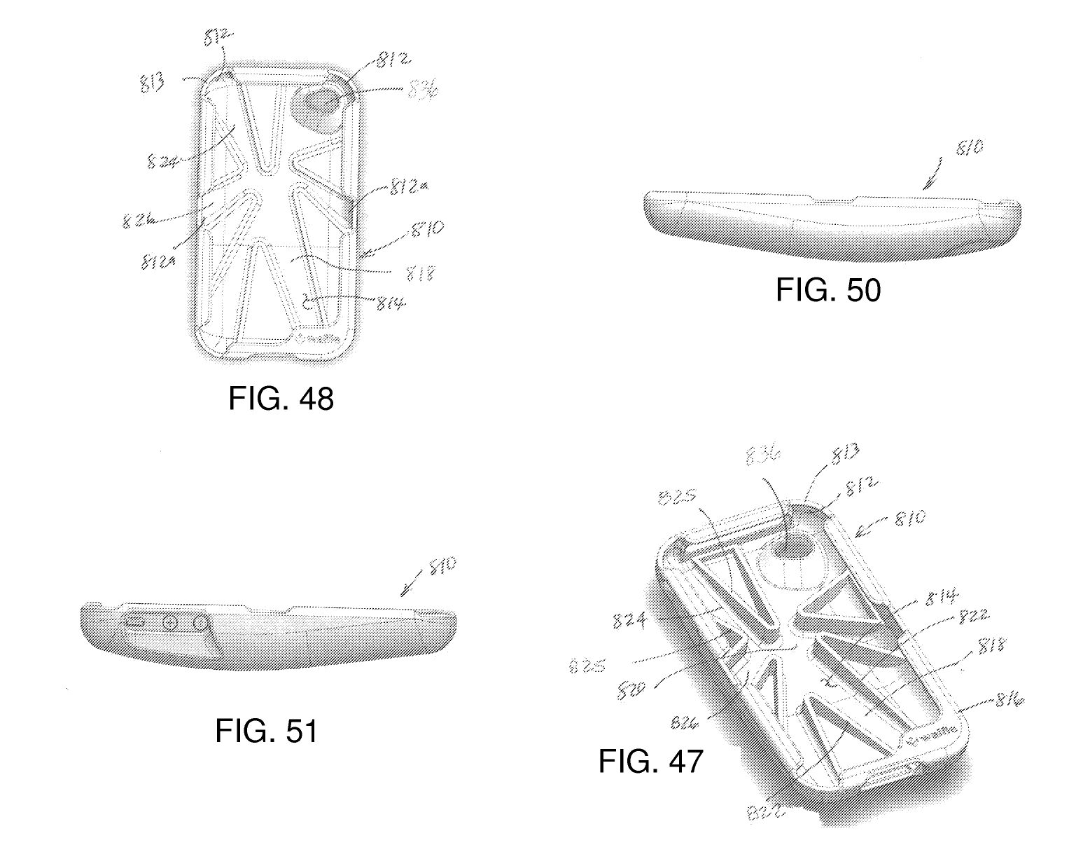

Referring to FIG. 46-52, the numeral 810 generally designates yet another embodiment of the cover of the present invention. Cover 810 is similar to cover 710 in that it includes outlet chambers 813 at three corners of the device and side outlet chambers 813a along the side of the device D, which may be generally located midway along the length of the sides of the device. Referring to FIG. 47, cover 810 similarly includes a base wall 814 with upwardly standing walls 822 which form channels 818, 824, and 826 for directing the sound from the speaker (which is also located at the right hand corner) to the various chambers around the perimeter of the device. In contrast to cover 710, each respective chamber 812 and 812a is generally smaller than the corresponding chambers for cover 710 to provide a more streamlined cover, but which also eliminates the pronounced griping surfaces provided by the transition region formed adjacent chamber 712 and 712a of cover 710. Cover 810 may also incorporate a split construction.

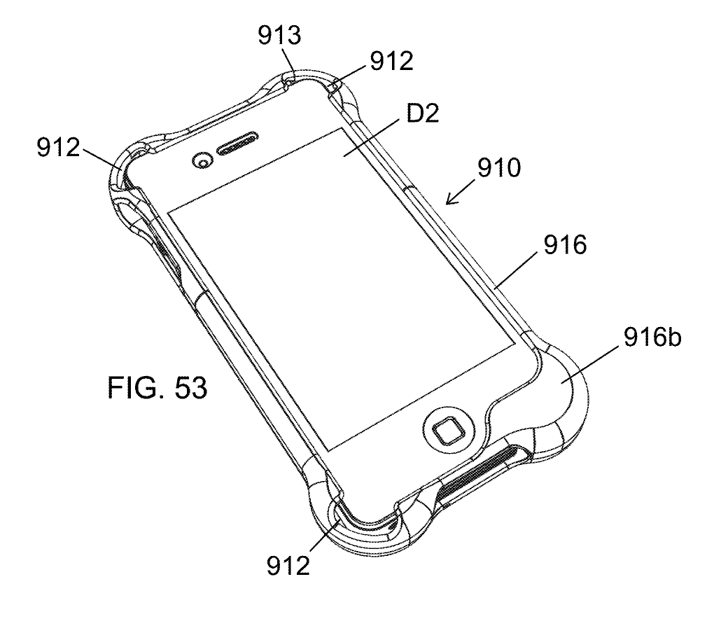

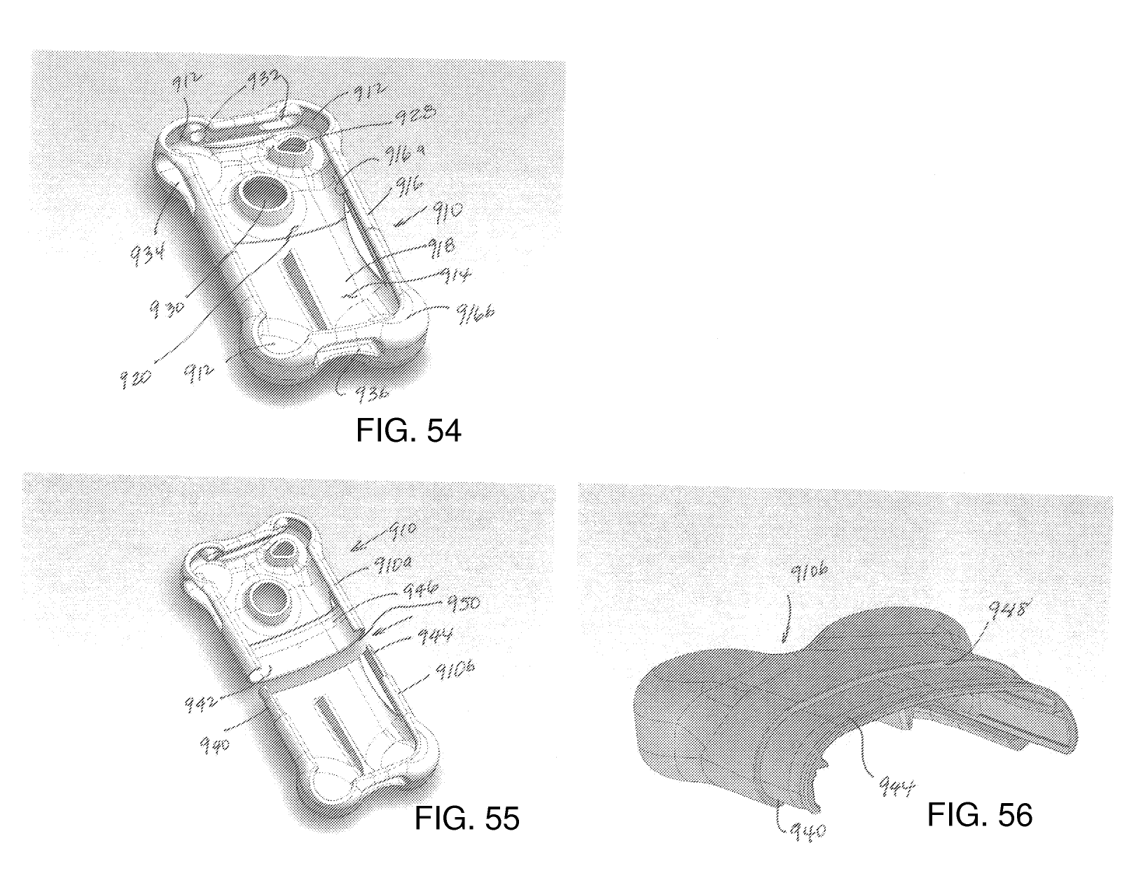

Referring to FIGS. 53-55, the numeral 910 generally designates yet another embodiment of a cover the present invention. Similar to cover 710, cover 910 includes enlarged chambers 913 of three of the respective corners of the device D, which tend to further increase the sound output from the cover and device. In the illustrated embodiment, cover 910 includes a single channel 918 that is in communication with a speaker (which is similarly located at the lower right hand side of the device as viewed from FIG. 53), which directs the sound from the speaker inwardly behind the device between the device body and the cover into the central enlarged chamber 920 which is in communication with the respective chambers located around the three corners of the device. In this manner, cover 910 adopts a simplified approach to harnessing and concentrating the sound waves and further distributing the sound waves to its respective outlet chambers located remotely from the speaker. Again, each of the covers may incorporate different access openings to accommodate the various devices. For example, cover 910 includes two rearwardly extending openings 928 and 930 which are configured to provide access to allow use of the camera and visibility of smartphone logo. Additional access openings 932, 934 and 936 may also be provided to allow access to the ports and controls of the specific device to which cover 910 is mounted. Again, to minimize sound leakage the cover may be sealed against the device body around each of the access openings.

Similar to the previous embodiments, cover 910 optionally incorporates a split construction with an upper half 910a and lower half 910b, which couple together by way of a friction fit or snap fit connection between a flange 940 formed on lower cover half 910b and the inwardly facing surface 942 of the lower end of upper cover half 910a. Optionally, flange 940 may incorporate a recess or other surface relief for cooperating with a corresponding relief 946, such as raised relief, on upper cover half 910a to provide a snap fit coupling between the two cover halves.

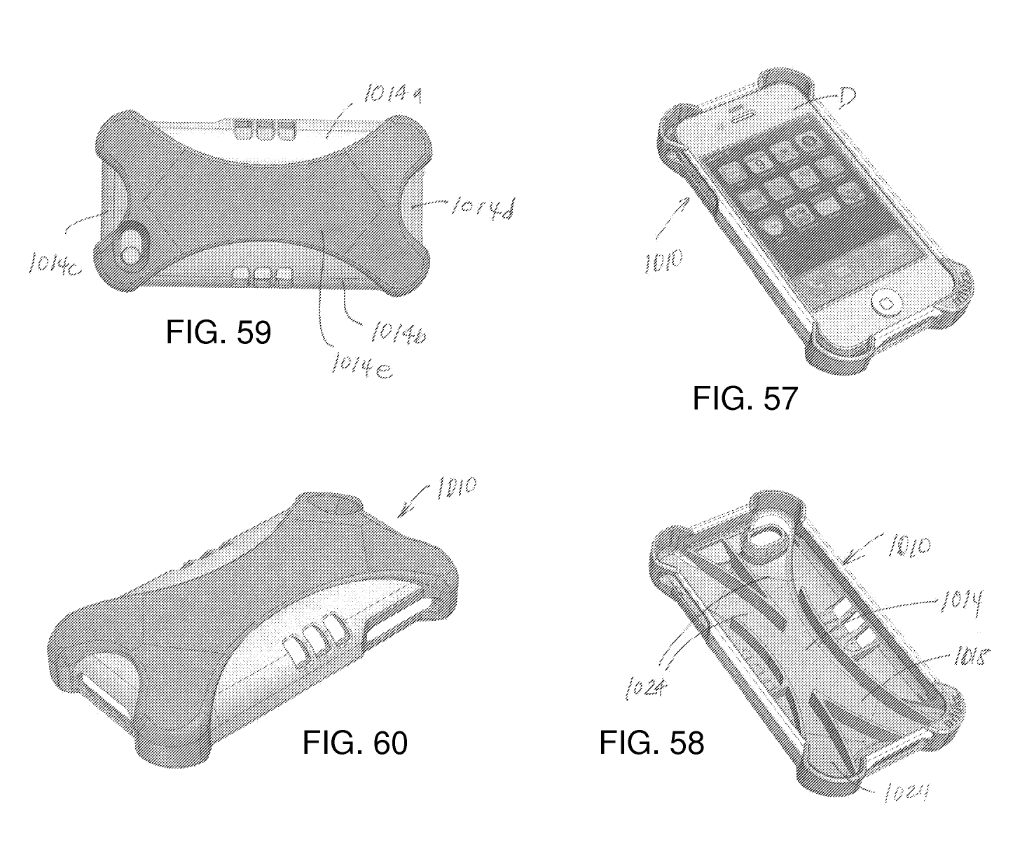

Referring to FIGS. 57-60, the numeral 1010 generally designates yet another embodiment of a cover the present invention. Cover 1010 is similar to cover 610 but is formed as a unitary cover. Thus, as noted, the base wall 1014 of cover 1010 may be formed from sections 1014a, 1014b, 1014c and 1014d, which are preformed as inserts from a relatively rigid polymeric material, such as a plastic, and which are placed into a mold and then molded with a second material over the inserts, which forms the back wall 1014e and balance of the base wall 1014. Back wall 1014e is formed from a more flexible and energy absorbing material, such as a structural gel, silicone, rubber or other elastomeric materials so that the cover can be stretched or bent to fit over the device. Alternately, cover 1010 may be formed from two shot molding with a first material for forming section 1014a, 1014b, 1014c and 1014d and the second material for forming the more flexible back wall. For further details of cover 1010 reference is made to cover 610.

Further, back wall 1014e is formed with a more defined offset from base wall 1014 so that the depth of the channels 1018 and 1024 may be increased and further more rounded to further increase the smoothness of the respective channels. In this configuration, it has been found that echoes are even more reduced if not eliminated and further the sound transmission is even more efficient so the perceive volume of the sound waves as they exit the cover is noticeably increased, even over the other illustrated embodiments.

In an alternate embodiment, the plenum space and/or channels for sound harnessing and concentrating the sound of the cover may be incorporated into a separate insert that is inserted between the cover and the device body or interiorly of the device itself. Further, as described below, the plenum space and/or channels may be incorporated into the device body itself. For example, the inside of the device body or the device body wall itself may incorporate a plenum and/or internal channels that are in communication with the speaker(s) and with one or more outlet chambers formed in the device body, for example, formed at the corners and/or sides of the device body and/or at the back side of the device body.

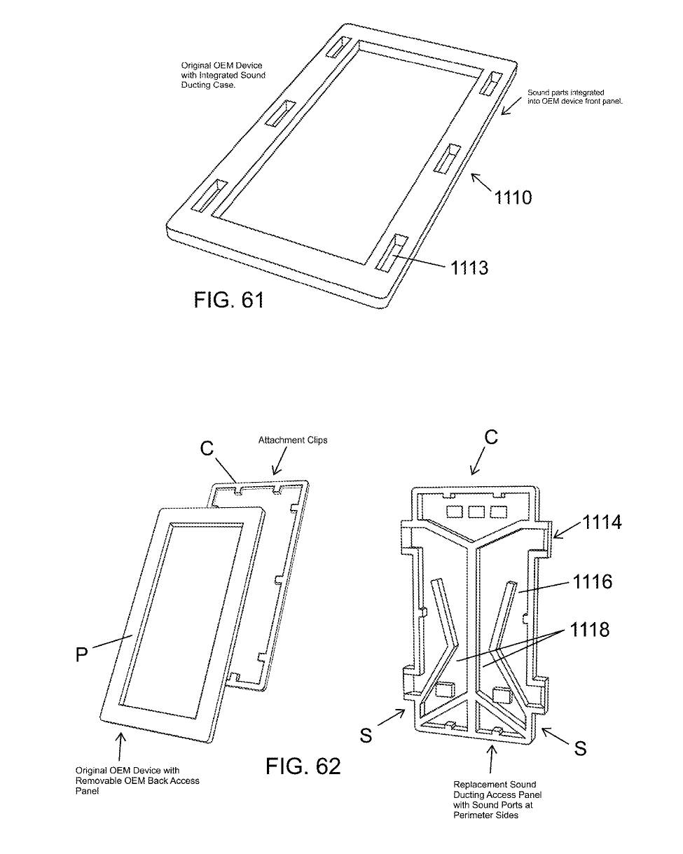

Referring to FIGS. 61 and 62, the numeral 1110 designates a device incorporating the sound wave harness and concentrating technology of the present invention. For example, a standard front panel or bezel (not shown) may be removed and replaced with a modified front panel 1112 that incorporates one or more outlet opening 1113. Similar to the covers described herein, the outlet openings may be located adjacent the corners of the device and along the sides so that the sound is directed the user. To harness the sound waves from a speaker or speakers S supported in the device, for example on a clip C, an insert 1114 may be placed between a standard back panel P (or a modified back panel) and the clip, which includes a plenum space and one or more channels 1118 of the types described above in reference to the covers.

For example, insert 1114 includes a base wall 1116 with a plurality of upwardly extending walls 1122 that form the channels (1118) for harnessing sound from speakers S and directing the harnessed and concentrated sound waves to openings 1113. Similar to cover 1010, some of the outlet openings may share a channel and be located at the end of the shared channel or as may have their own channels so each channel is associated with an outlet opening.

In each of the above covers or inserts or panels, the covers or inserts or panels may be formed from a variety of different materials, including multiple materials. For example, the covers or inserts or panels or parts of the covers or inserts or panels may be molded from a plastic, wood, metal, polymers, rubber, including clear or translucent material, such as clear or translucent plastics. Further, each of the covers or inserts or panels may be formed from injection molding, rotational molding, blow molding, compression molding, thermoforming, multishot molding, stamping, die casting, machining, or forging, including an insert molding process where one or more portions of the cover is preformed from one material, and another portion of the cover is molded over the preformed part(s) from another material.

For example, referring FIG. 31, the base wall 614 of cover 610 may be formed from inserts 614a, 614b, 614c and 614d which are preformed from a relatively rigid polymeric material, such as a plastic, which is placed into a mold and then molded with a second material over the inserts forming the balance of the back wall 614e. For example, wall 614e may be formed from a more flexible and energy absorbing material, such as a structural gel, silicone, rubber or other elastomeric materials.

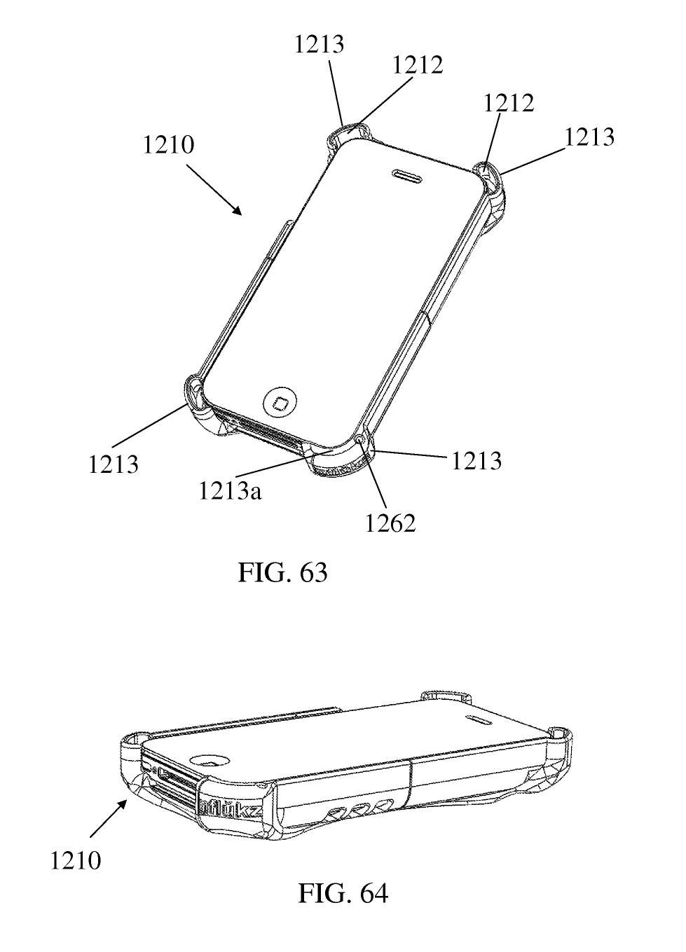

Referring to FIG. 63, the numeral 1210 designates yet another embodiment of the cover of the present invention. Similar to the previous embodiments, cover 1210 includes a plurality of pockets 1213 located at the four corner of the cover to align with the corners of the hand-held device, with one of the pockets including an upper wall or flange 1213a to cover and optionally seal the speaker of the hand-held device. As described above in reference to the other embodiments, each of the other pockets include or form sound ports 1212, which in the illustrated embodiment are defined by the lips or edges of the respective pockets. Cover 1210 also includes one or more channels of the types described above so that the sound waves emanated from the speaker are redirected by the channel(s) formed in the cover (or by an insert between the cover and the hand-held device) to the respective sound ports.

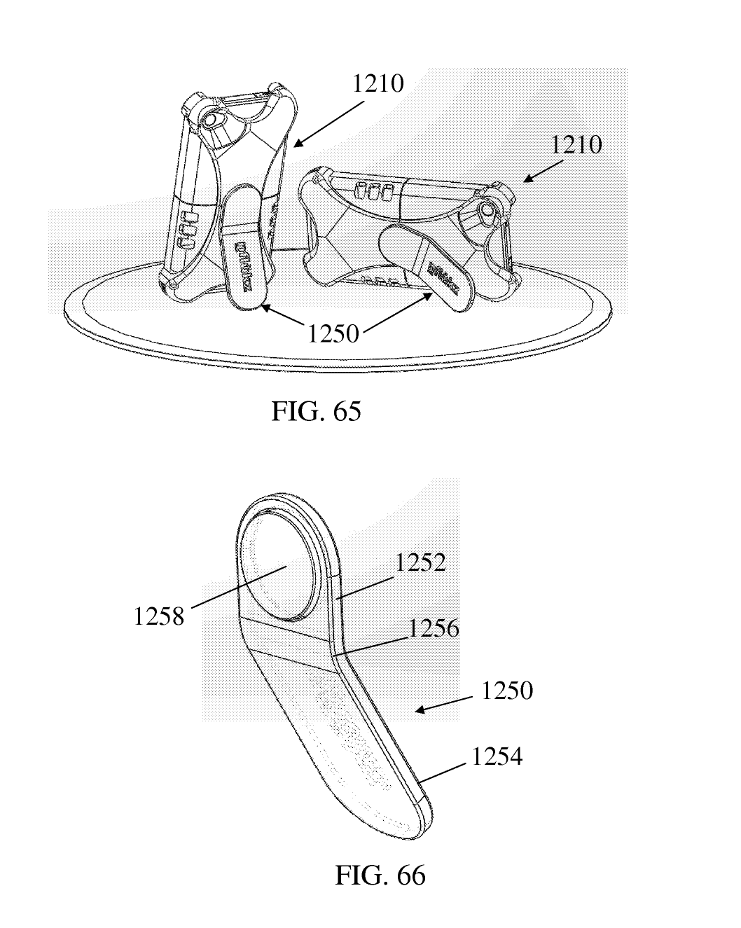

Referring to FIG. 65, cover 1210 (as well as any of the previously described covers), may incorporate a stand 1250. For example, stand 1250 may be formed from a rigid material such as plastic, metal, or the like and is formed with a mounting portion 1252 and an extended angled leg 1254. Mounting portion 1252 may incorporate a coupler 1258, such as an earth magnet, which releasably mounts to the cover. Coupler 1258 may be molded in or secured to the mounting portion by a fastener, such as an adhesive or a snap-fit coupling. Cover 1210 similarly may include an earth magnet, which is either mounted (such as by an adhesive or a snap-fit connection) to the cover at its back wall or molded or potted therein. Consequently, stand 1250 may be mounted to the cover and repositioned in a number of different orientations, with two such orientations shown in FIG. 65. In this manner, stand 1250 may be quickly and easily mounted to a cover and just as quickly and easily removed from the cover

Alternately, stand 1250 may be flexible and formed from, for example, a material with shape memory so that the configuration of the stand may be changed to change orientation of the cover and hand-held device supported therein. For example, stand 1250 may incorporate a living hinge 1256 to allow the leg 1254 to be moved between multiple orientations to adjust the angle of the hand-held device cover and hand-held device.

Furthermore, stand 1250 may be integrally formed with cover 1210. For example, stand 1250 may be orientated in a planar arrangement when in a stowed position for example in a recess formed at the back of the cover, but then partially deployed, for example leg 1254 may be deployed from the recess to support the cover and the hand-held device.

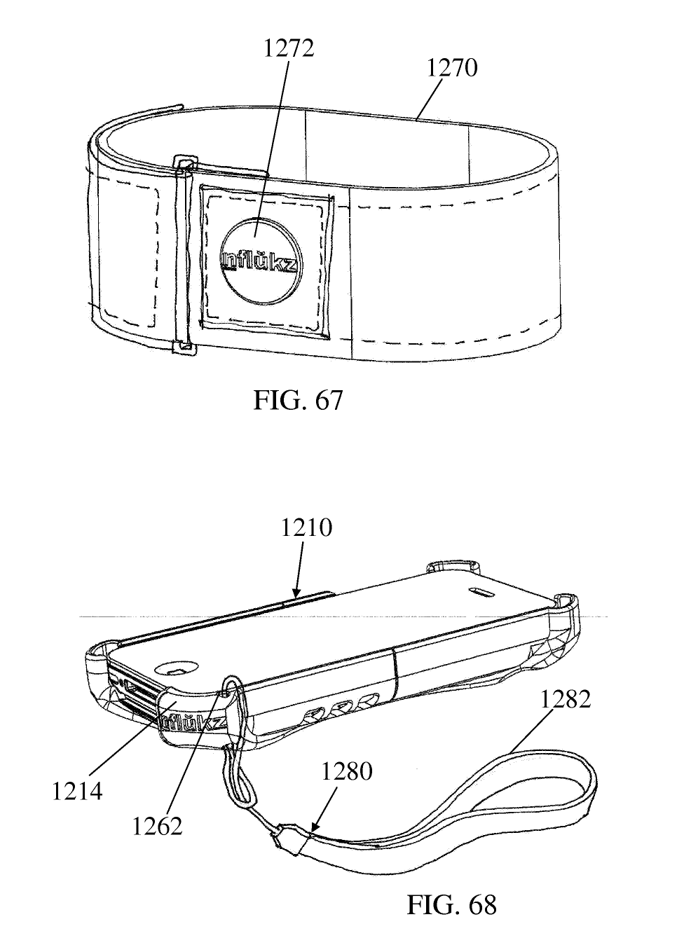

Referring to FIG. 67, as noted above, cover 1210 may incorporate an earth magnet. The earth magnet may be also used to mount the cover to a band 1270, for example, an arm band so that the cover and hand-held device may be mounted to a person's arm wearing band 1270. For example, band 1270 may be formed from a conventional arm band strap with a fastener, such as Velcro straps, to secure the band around a wearer's arm. The earth magnet 1272 may be mounted to the band by a fastener, such as adhesive, which can then releasably couple to the earth magnet of the cover. For example, suitable earth magnets may require a pull force of 30 pounds or more to decoupled the magnets.

Referring to FIG. 68, optionally cover 1210 may incorporate a transverse opening through the cover to allow a lanyard 1280 to be looped through and secured to the cover. Optionally, lanyard 1280 may incorporate a loop 1282 for extending around a user's wrist, for example. In the illustrated embodiment, the transverse opening 1262 extends through the cover at one of the pockets, namely the pocket that extends over the speaker. However, it should be understood that the transverse opening 1262 may be provided at other locations of the cover.

While described as providing a mount to an arm band, it should be understood that the earth magnet may also be used to mount the cover to other surfaces, such as a dashboard, windshield, a wall petition, or the like to allow a user to mount the cover and hand-held device in whatever environment the user is present. Furthermore, the cover may be sold with a separate mounting device that cooperates with the mounting device on the cover so that the cover and mounting device may be sold as a kit. For example, an earth magnet may be sold with the cover, which includes a removable backing strip to reveal an adhesive layer, which allows the user to mount the magnet to whichever surface they desire to allow the cover then to be supported by the magnet. Furthermore, while described as a magnet, other mounting devices may also be used.

Consequently, the mounting device allows a user to use the cover and hand-held device supported therein in a variety of different settings or environments and also allows a hands-free operation of the hand-held device and hands-free listening.

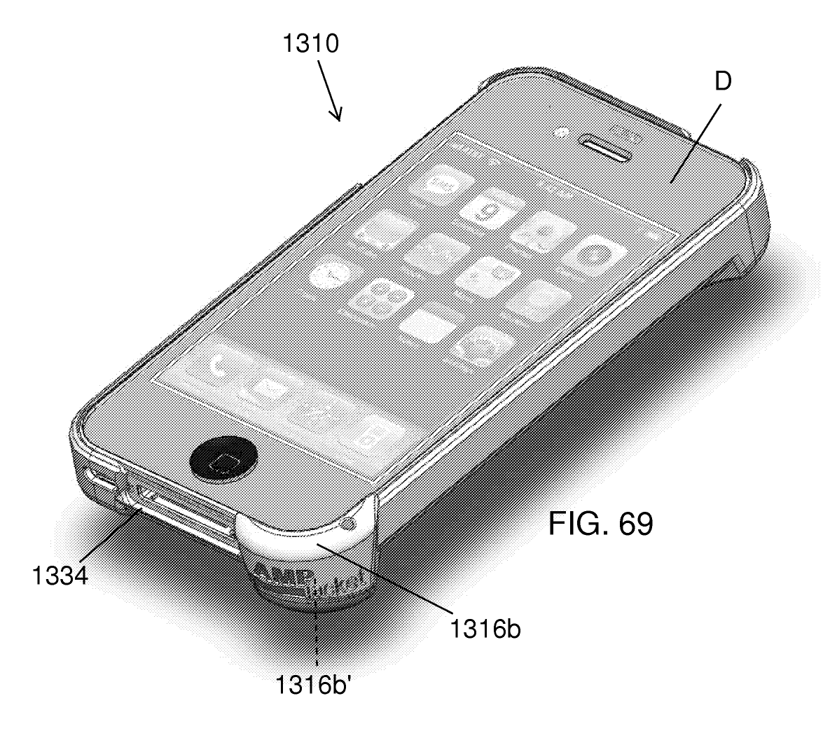

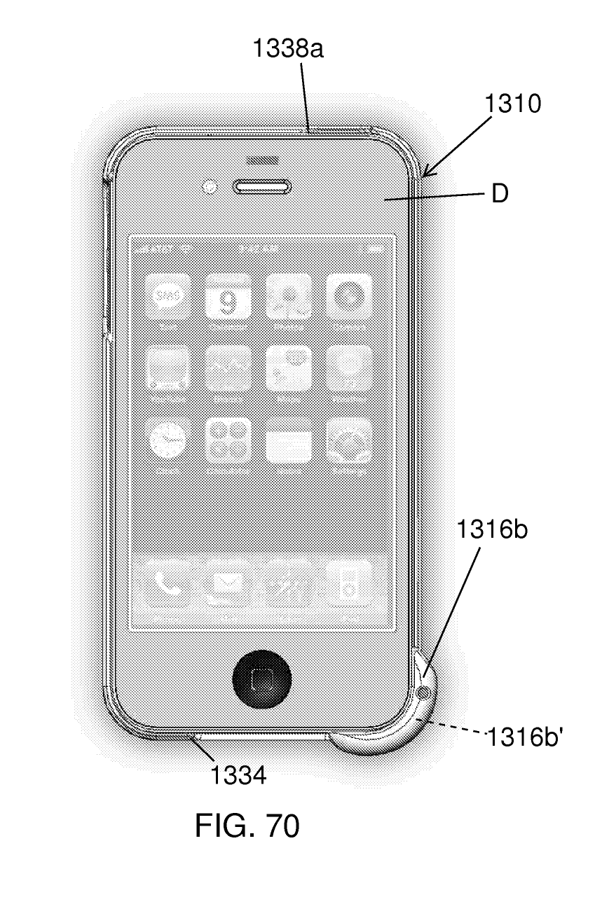

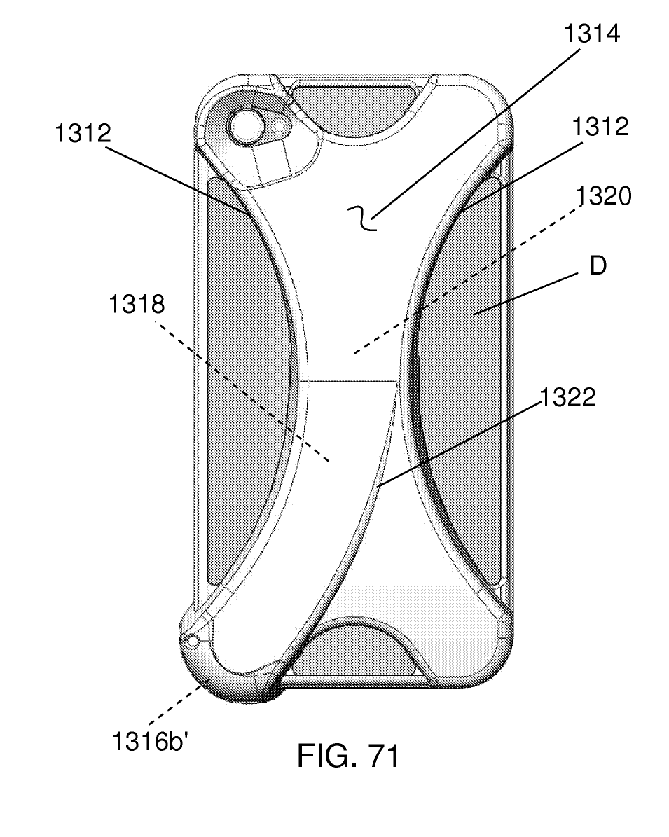

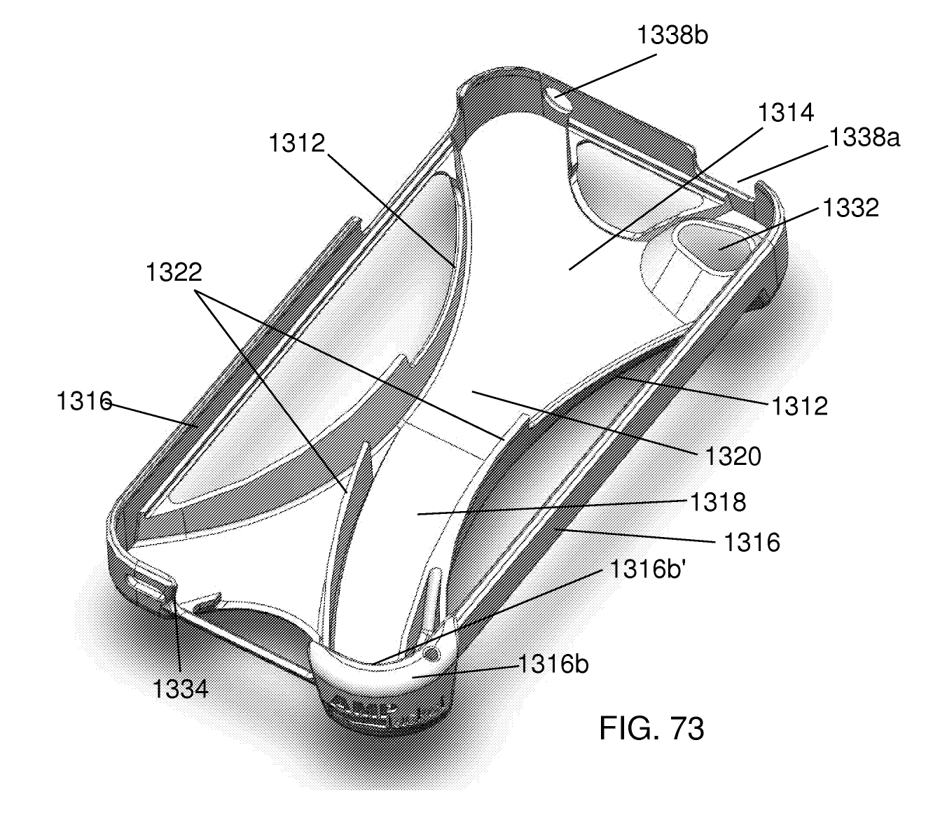

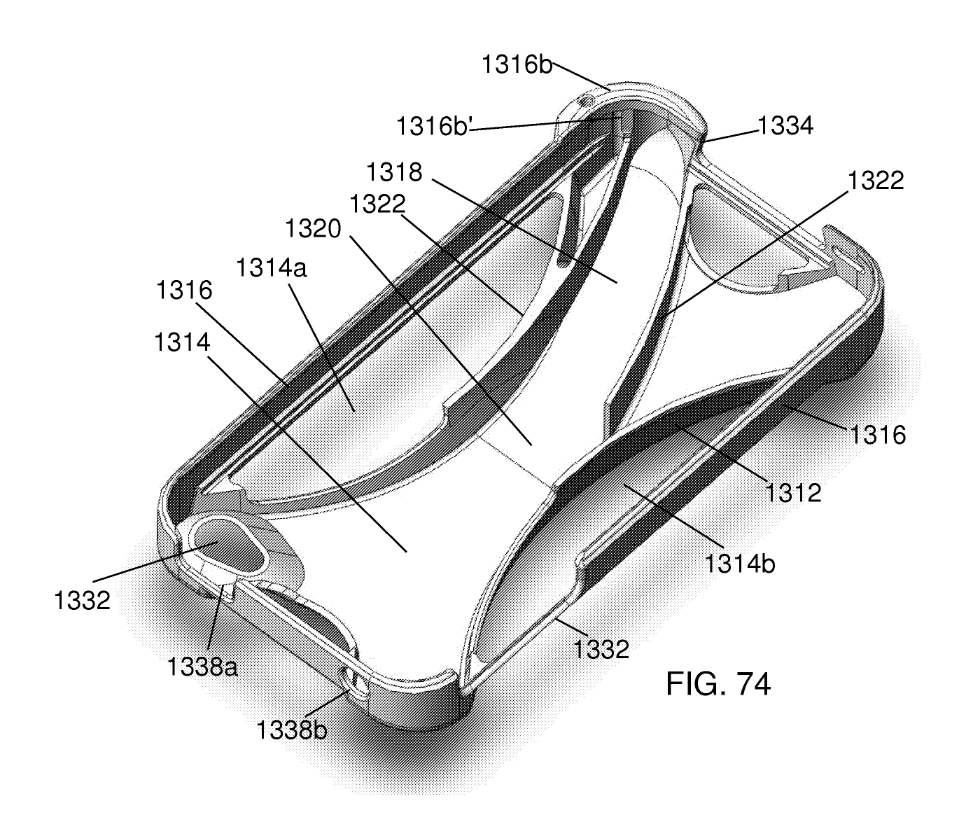

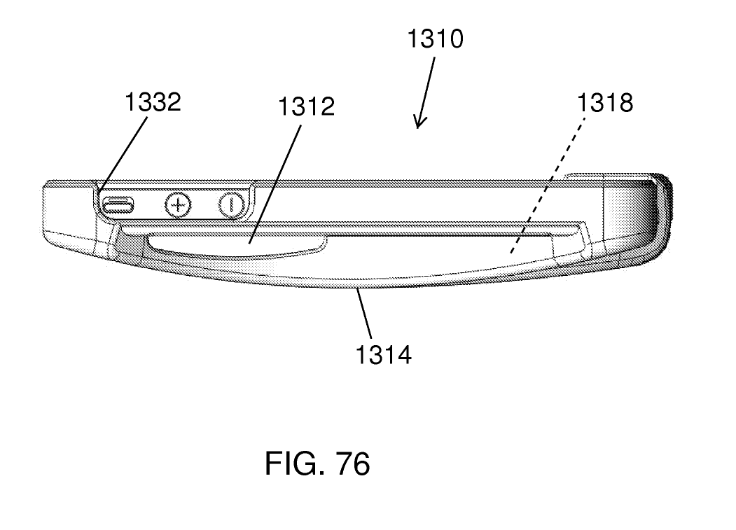

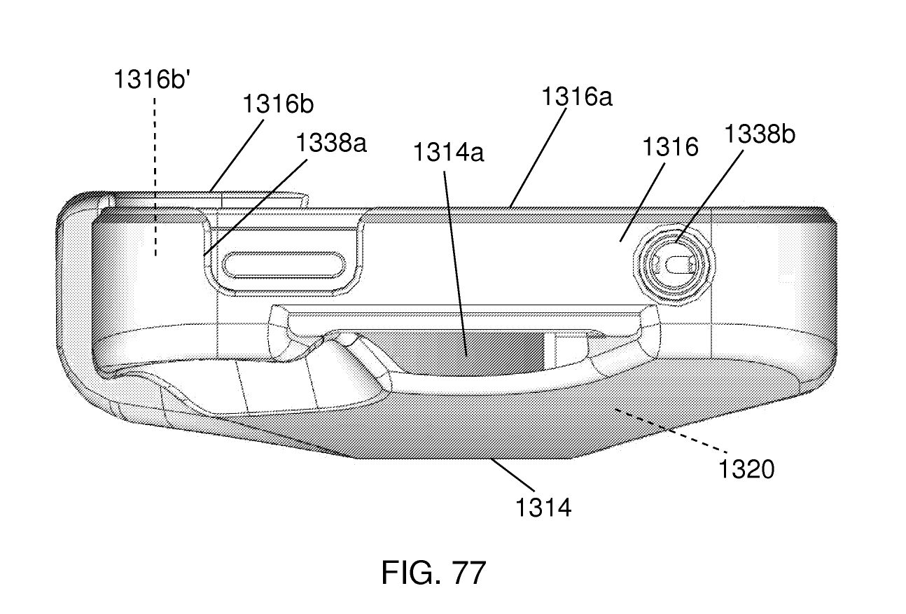

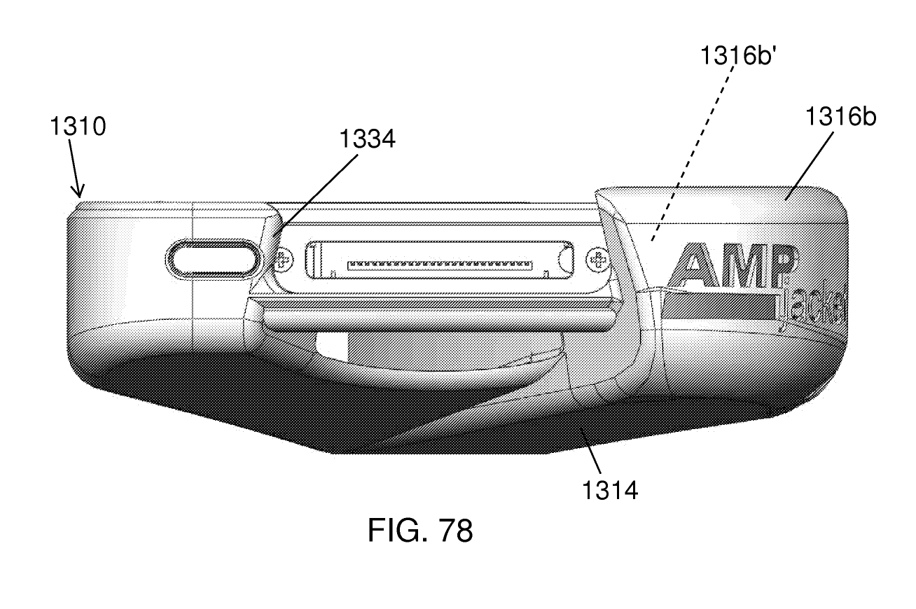

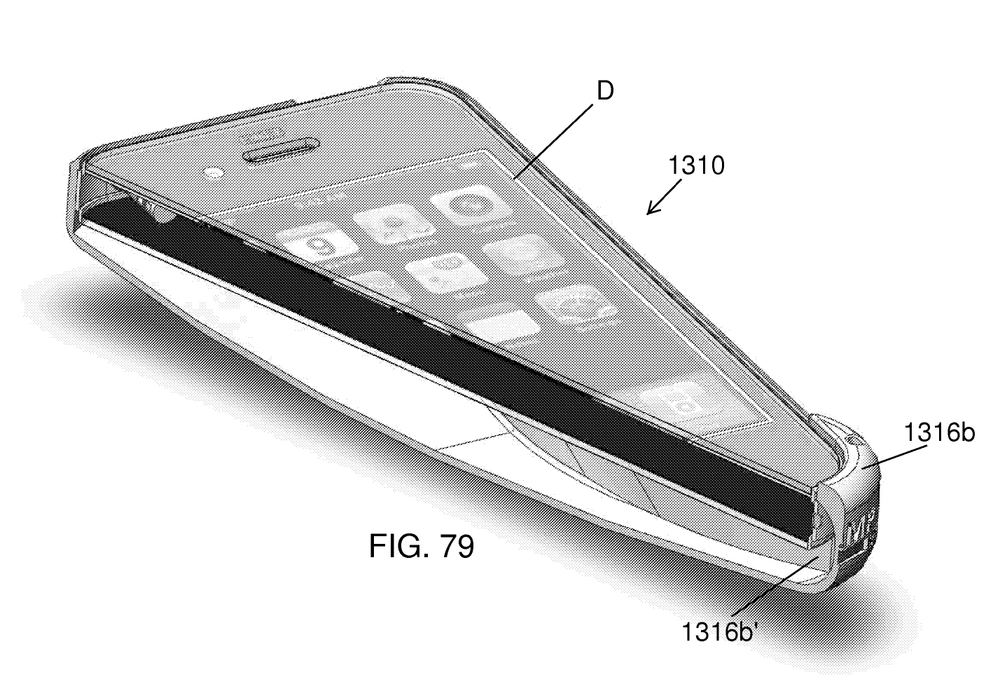

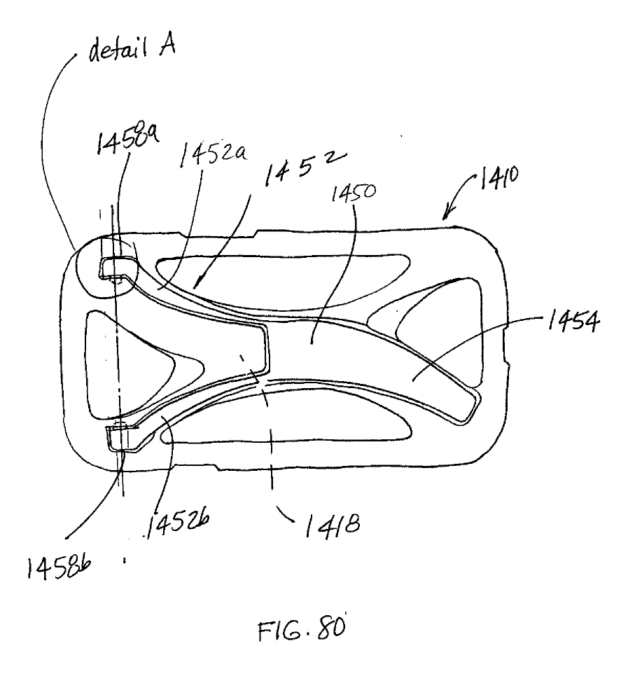

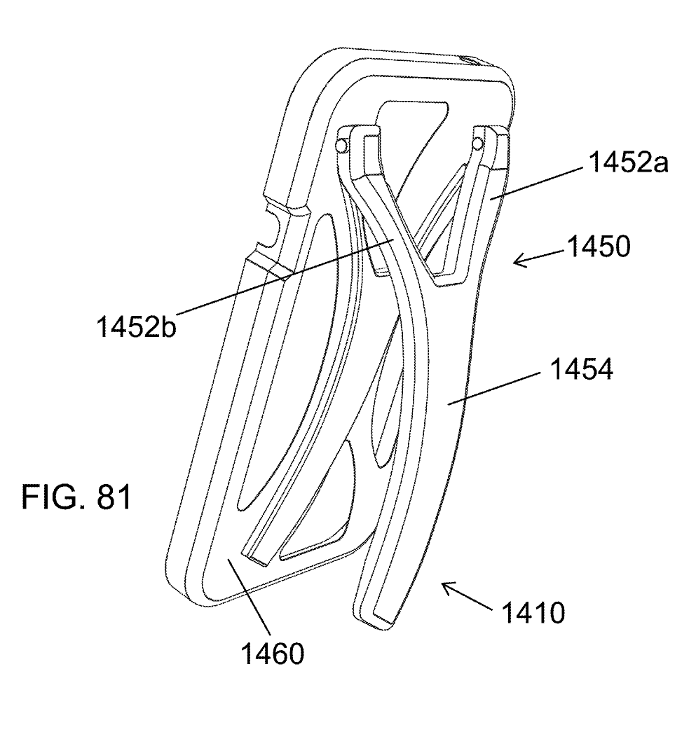

Referring to FIGS. 69-79, the numeral 1310 generally designates yet another embodiment of a cover the present invention. Cover 1310 is also optionally formed as a unitary cover and may be formed from a single relatively flexible material or may be formed from two or more materials in a similar manner as described above. Similar to the previous embodiments, cover 1310 includes a cover body with a base wall 1314, which when mounted to the device is spaced from the device body form a plenum space between the device body and the cover, and an upwardly extending perimeter side wall 1316. Further, the cover may be configured and arranged to seal against the device body around the speaker (or speakers) so that essentially all of the potential audible sound energy developed by the speaker (or speakers) of the device can be harnessed and directed into the plenum space for redirecting, in this case, to back side of the cover.

Referring again to FIG. 69, side wall 1316 includes a lip 1316a that extends around the perimeter and optionally generally seals against the device body. Side wall 1316 includes an enlarged region to form a chamber 1316b′ adjacent the device body and the speaker, with lip 1316a still generally following the outer perimeter of the device body. Back wall 1314 extends from the corners of the side wall inwardly and includes inwardly extending side walls that extend to and optionally seal against the back of the device but terminate short of the back of the device over one or more discrete regions to form outlet openings 1312 that face in a direct generally parallel to the back side of device D. In the illustrated embodiment base wall 1314 has a generally dog-boned shaped configuration which is spaced inwardly and optionally disconnected from side walls 1316 between the corners of the cover to form openings 1314a through cover 1310. Optionally, these openings can be eliminated by a second material, for example, an impact absorbing material, such as gel, foam, or the like, that joins or fills the space between the disconnected or rail portions of the side wall 1316 and the back wall 1314.

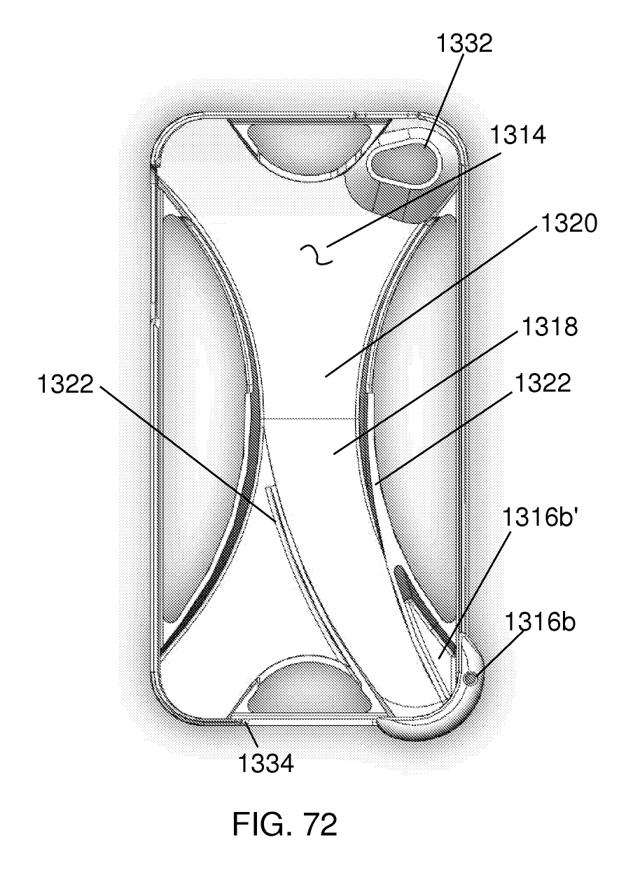

Referring to FIGS. 72-74, to redirect the sound from the speaker to the outlet openings 1312, cover 1310 incorporates at least one channel 1318 which is in communication with the speaker on one end by way of chamber 1316b′ and in communication with another chamber 1320 at its distal end, which forms part of the plenum space. In the illustrated embodiment, chamber 1320 is in direct communication with each of the outlet openings 1312.

Channel 1318 is formed by upwardly standing side walls 1322, which are optionally integrally formed with base wall 1314 of cover 1310, such as by molding or by being post applied using an adhesive. Further, upwardly standing side walls 1322 are sized such that the upper distal edge of the respective side wall 1322 extends to and optionally seals against the back of the device body (when the cover is mounted to the device) so that the sound waves emitted from the speaker are directed along the channel to chamber 1320 and then out openings 1312. Thus essentially all of the sounds waves emitted from the speaker are directed into chamber 1316b′ and then down channel 1318 from its proximal end to its distal end adjacent central chamber 1320 and thereafter travel to outlet openings 1312.

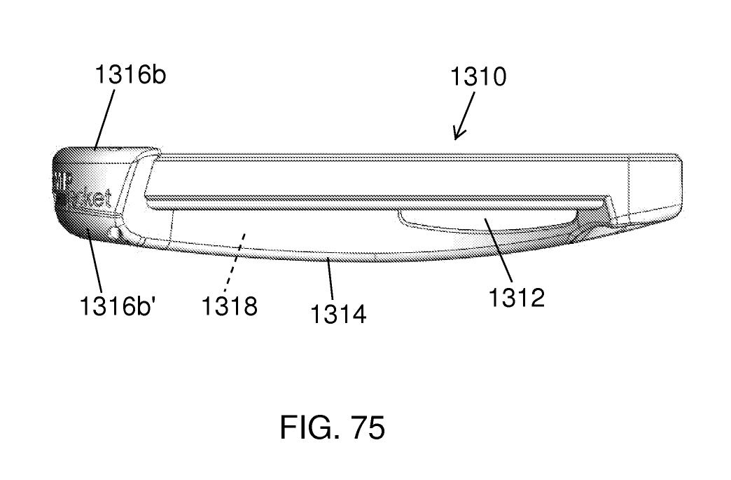

Optionally, channel 1318 is configured to operate like an internalized megaphone for natural amplification within the handheld device case or within the handheld device itself (as described more fully below). For example, walls 1322 may be a tapered so that channel 1318 concentrates the sounds waves and thus prevents them from scattering. Optionally base wall 1314 of cover may be flat or may have a slope, such as shown in FIG. 75, to thereby form a generally cone or horn shaped channel. In addition, walls 1322 may be curved to reduce interference with the sound waves.

Referring to FIG. 80, another embodiment of a cover 1410 the present invention is shown with a deployable and optionally removable stand 1450. Although cover 1410 is illustrated as a cover similar to cover 1210, it should be understood that the cover may be configured like any of the other covers described and illustrated herein, including other covers not disclosed herein. For example, stand 1450 may be formed from a rigid material such as plastic, metal, or the like and is formed with a mounting portion 1452 and a leg 1454. In the illustrated embodiment, mounting portion 1452 comprises a bifurcated mounting portion with two arms 1452a and 1452b, which are pinned to the back wall of cover 1410. As best seen in FIG. 81, when stand 1450 is pivoted outwardly from the back of the cover, leg 1454 can be used to prop the hand-held electronic device supported in cover 1410. And, the angle of tilt depends on which portion of leg 1454 is used to prop up the cover and hand-held electronic device.

Optionally, the back of the cover may have one or more recessed or relief portions 1460 that can partially of fully receive the stand when it is returned to its stored position so that the stand may be generally flush with the cover wall and generally follow the surface topology of the cover so that when stowed cover 1410 will have a similar surface topology to cover 1210 except for the gaps that would be formed between the stand and the cover.

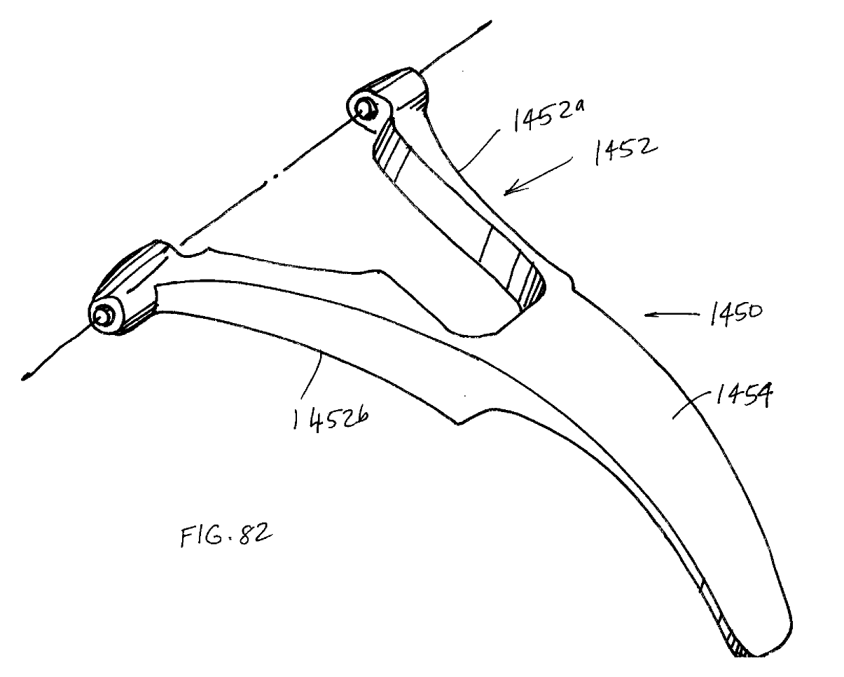

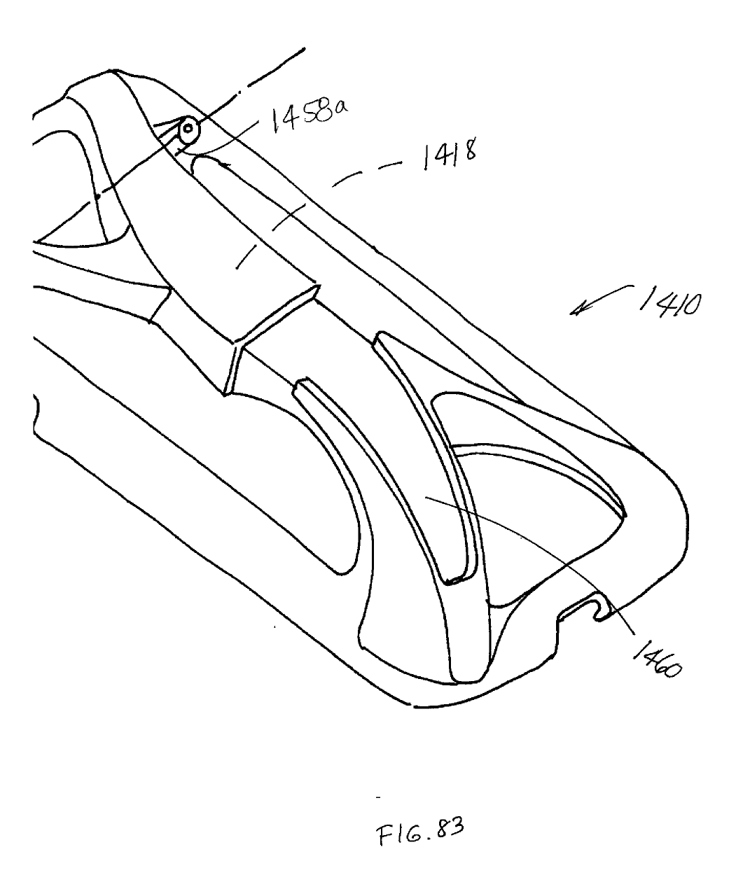

Further, as best seen in FIGS. 80-82, arms 1452a and 1452b and leg 1454 may be tapered to further facilitate stand following the surface topology of the cover. To that end, the space between arms 1452a and 1452b may be size to straddle the portion of cover 1410 that forms the channel 1418, which as described and generally shown is similar to channel 1218.

In the illustrated embodiment, arms 1452a and 1452b may extend into recesses 1458a and 1458b formed in back wall of cover 1410, which may be optionally configured to allow mounting portion 1452 to be disconnected and reconnected. Further, arms 1452a and 1452b and recesses 1458a and 1458b may be configured to provide resistance over one or more ranges of motion. For example, when the stand is in its stowed position, arms 1452a and 1452b and recesses 1458a and 1458b may be configured to provide initial resistance to pulling the stand out from its stowed position. Similarly, arms 1452a and 1452b and recesses 1458a and 1458b may be configured to provide resistance to moving leg 1454 to specified stand positions and similarly provide initial resistance to pulling the stand out from its specified stand positions.

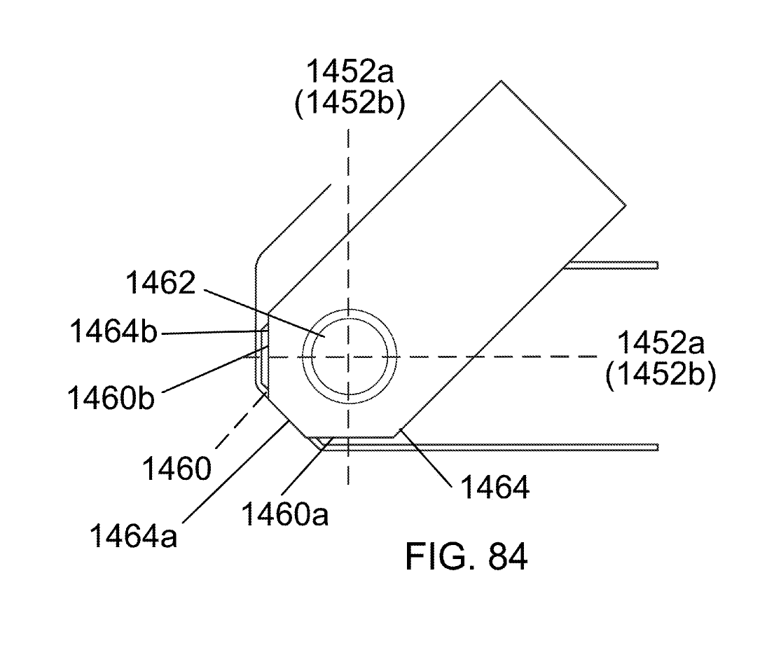

Referring to FIG. 84, each arm 1452a and 1452b may include a projecting pin 1462 for extending into a corresponding socket in the recess to thereby pivotally connect the arms to the cover. Further, the ends of the arms and the shape of the recesses may be configured to have similar profiles when the arms are in their closed positions (such as shown in the dotted lines in FIG. 84) with one or more flatted sections 1460a, 1460b, 1464a, 1464b and one or more enlarged lobes 1464c on the end of the arms, which are located so they when the arms are pivoted the surfaces frictionally interact to increase the friction at discrete positions of the arms (such as noted above) but then allow free unrestricted movement (or with reduced frictional interaction) of the arms over other ranges of motion.

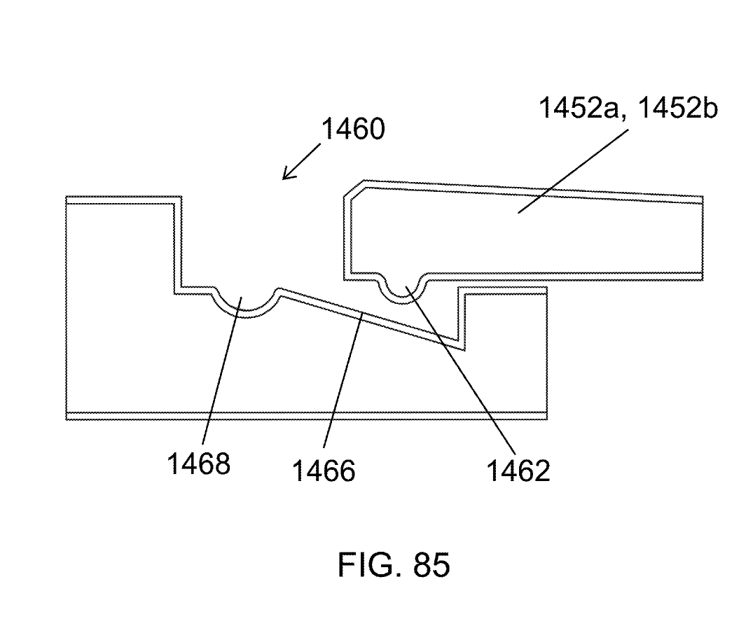

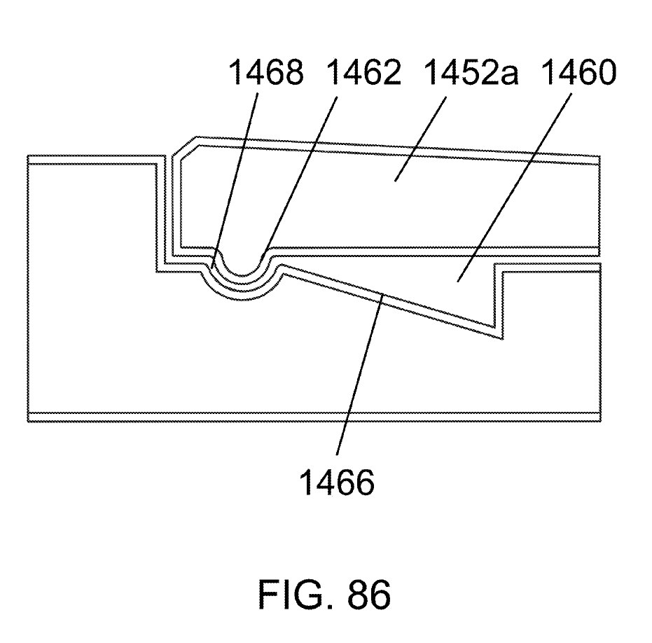

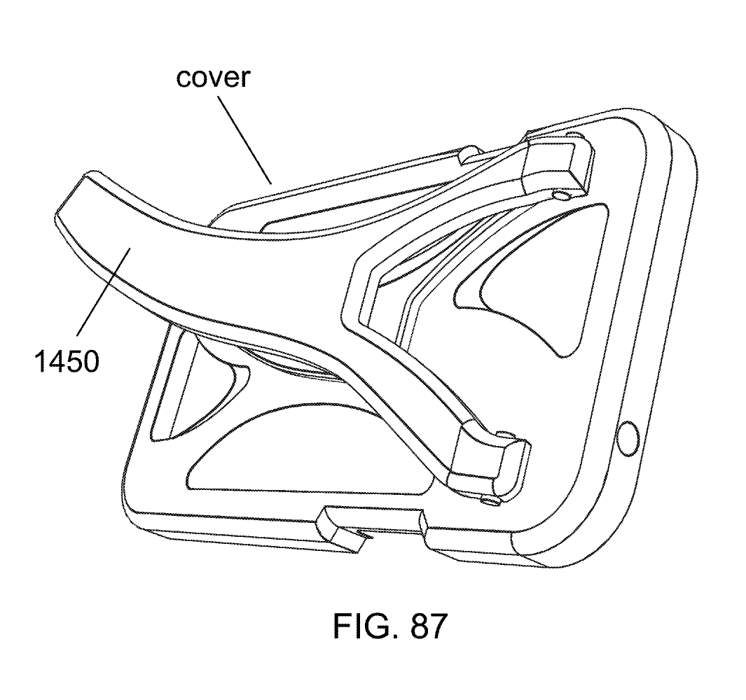

In addition, referring to FIGS. 85-86, recesses 1460 may include ramped surfaces 1466 to guide the ends of the arms into the recesses and further so that pins 1462 align with sockets 1468 to thereby pivotally couple the arms to the cover. In addition, sockets 1468 and pins 1460 may have diverging sides so that when a force is applied to the arms or mounting portion, the diverging sides generate a lateral force on the respective arms, which are formed from a material with sufficient resilience (such as a polycarbonate, including thermal polycarbonate (TPE)) to allow the arms to deflect and allow the pins to disengage from the sockets to thereby provide a removable stand and a stand that can be reconnected. In this manner, stand 1450 may be quickly and easily mounted to a cover and just as quickly and easily removed from the cover.

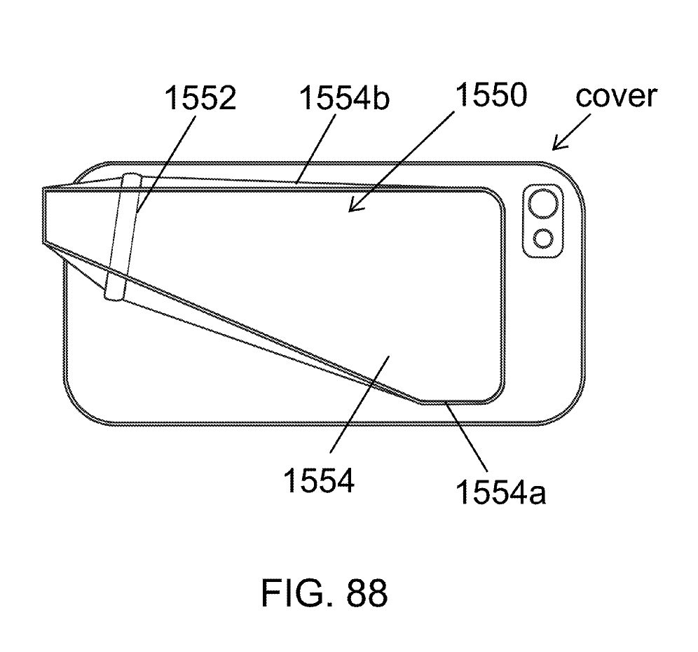

Referring to FIG. 87, a stand 1450′ similar to stand 1450 is illustrated mount to a cover that is configured for use on a tablet or another large electronic device. Stand 1450′ may be constructed in a similar manner to stand 1450 (and therefore reference is made to stand 1450 for mounting details) but enlarged to accommodate the large cover. FIG. 88 illustrates a modified stand 1550, which is mounted by a single mounting arm 1552 and further includes an enlarged leg with a trapezoidal shaped body that provides two flattened landing surfaces 1554a and 1554b, which are generally parallel to each other, with landing 1554a providing a greater tilt to the cover and hand-held device supported in the cover as compared to landing surface 1554b, which may hold the cover and hand-held device close to vertical.

The covers, inserts, and panels may be molded using two shot molding with one or more portions of the covers, inserts, and panels being molded with a first material and another or other portions of the covers, inserts, and panels being molded from a second material. In this manner, the covers, inserts, and panels may be formed using materials that can optimize it for the desired function. For example, at least a portion of the covers, inserts, and panels may be formed from a flexible elastic material to provide a more energy absorbing characteristic for the covers, inserts, and panels, while, for example, the base wall or at least the inwardly facing side of the base wall may be formed from a more rigid material to direct the sound waves and limit the absorption of the sound waves into the cover. Additionally, portions of the channels may be selectively formed from materials with more sound absorbing characteristics, such a s less dense material or rubber or rubberized material, to absorb selected frequencies (or frequency) of the sound waves to adjust the tone emitted by the covers, inserts, and panels and thereby filter out one or more desired frequencies. For example, the respective base walls or side walls of the channels may be formed from materials that absorb some of the high frequency range sound waves thereby reduce the tininess of the sound waves emitted from the respective chambers or openings of the covers, inserts, and panels. Alternately, the base wall or side walls of the respective channels may be formed from material that absorb some of the low frequency sounds of the sound waves to reduce the base sounds of the sound waves emitted by covers, inserts, and panels. In addition to concentrating the sound waves, the respective covers, inserts, and panels may be configured by way of material selection or geometric selection (e.g. forming the channel from thin, flexible walls) to enhance or suppress certain frequencies of the sound waves emitted by the speaker. Further, a sound absorbing material may be applied thereto, for example, by dipping, spraying, or by way of an adhesive.

While several of the covers are illustrated with a split construction, as described, the covers may be formed from materials that are sufficiently flexible to allow a unitary construction. For example, when made from a flexible material such as gel or silicone, the channels may be formed from inserts that are pre-molded or formed during two shot molding.

Accordingly, when mounted to or in a handheld device with one or more speakers, the plenum space and/or channels of the present invention provide improved sound volume (perceived volume) and/or quality. The channels naturally amplify the sound energy by the use of creating a naturally occurring standing wave to amplify the sound energy.

While several forms of the invention have been shown and described, other changes and modifications will be appreciated by those skilled in the relevant art. For example, in some devices the speakers may be provided at other locations, therefore, the number, size, shape and locations of the outlet channels and access may vary from device to device. Therefore, it will be understood that the embodiments shown in the drawings and described above are merely for illustrative purposes, and are not intended to limit the scope of the invention which is defined by the claims which follow as interpreted under the principles of patent law including the doctrine of equivalents. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “the,” is not to be construed as limiting the element to the singular.

The embodiments of the invention in which an exclusive property right or privilege is claimed are defined as follows:

1. A cover for a hand-held device, the hand-held device having a device body and a speaker, the speaker having an output, said cover comprising:
a cover body, said cover body configured for covering a portion the device body and for covering the speaker; and
a channel for positioning between said cover body and the device body, and said channel configured to form a sound duct when mounted adjacent the back side of the device body and for communicating with the speaker when the cover is mounted to the hand-held device and for redirecting the sound waves emitted from the speaker to a location remote from the speaker without the use of power.

2. The cover according to claim 1, wherein said cover body includes said channel.

3. The cover according to claim 1, wherein said cover body includes a back wall and a perimeter body portion, said perimeter body portion configured for at least partially extending around a perimeter of the device body when the cover is mounted to the hand-held device.

4. The cover according to claim 3, wherein said back wall includes said channel.

5. The cover according to claim 1, in combination with a handheld device, said device having a back side and a front side, said front side having a display screen, when said cover is mounted to said device, said channel is configured to extend along said back side of said device body.

6. The cover according to claim 5, wherein said channel has a sealing surface, such as a sealing or gasket lip, said sealing surface sealing against said back side of said device body when said cover is mounted to said device.

7. The cover according to claim 1, wherein said cover is configured for sealing around the speaker and for directing substantially all of the sound waves emitted from the speaker into the channel when the cover is mounted to the hand-held device.

8. The cover according to claim 1, wherein said channel is adapted for being in communication with the speaker for redirecting at least a portion of the sound waves emitted from the speaker to at least one location remote from the speaker when the cover is mounted to the hand-held device.

9. A cover for a handheld device, the handheld device having a device body and a speaker, the speaker having an output, said cover comprising:
a cover body, said cover body configured for covering at a portion of the device body and for covering the speaker, said cover body forming an outlet opening; and
a channel for being communication with the speaker and for harnessing and concentrating sound waves from the speaker to said outlet opening, with said channel having a length and a cross section increasing in size along the length of the channel.

10. The cover according to claim 9, wherein said cover body forms a plenum space, said channel in communication with the plenum space for directing the sound waves to the plenum space, and said plenum space being in communication with said outlet opening.

11. The cover according to claim 9, wherein said cover body includes a base wall and a perimeter wall, said perimeter wall extending around and from said base wall, said perimeter wall forming said opening and an outlet chamber about said opening for positioning adjacent a portion of the device body.

12. The cover according to claim 9, wherein said cover body includes a base wall and a perimeter wall, said perimeter wall extending around and from said base wall, said base wall having said opening.

13. The cover according to claim 10, wherein said channel is formed by a pair of side walls, said side walls diverging in the direction of sound travel.

14. The cover according to claim 13, further comprising a second channel, said second channel in communication with the plenum space and said opening for directing the sound waves from the plenum space to the opening.

15. An electronic hand-held device comprising:
a housing having an outlet opening;
a speaker spaced from said outlet opening;
a plenum space in communication with said speaker and said outlet opening for directing sound waves emitted from said speaker to said outlet opening, and said plenum space configured to increase the perceived volume of the sound waves from the speaker without power.

16. The device according to claim 15, further comprising a channel, said channel being in communication with said speaker and said plenum space and for harnessing and concentrating the sound waves emitted from said speaker.

17. The device according to claim 16, wherein said channel has a closed cross-section, and said closed cross section increases in magnitude in the direction from said speaker to said plenum space.

18. A method of directing sound from a speaker in a hand-held device, said method comprising:
harnessing the sound waves emitted from the speaker;
adjusting the sound waves without the use of power; and
outputting the adjusted sound waves at a location spaced from the speaker.

19. The method of directing the sound from a speaker in a hand-held device according to claim 18, wherein said adjusting includes concentrating the sound waves at the location.

20. The method of directing the sound from a speaker in a hand-held device according to claim 18, wherein said adjusting includes concentrating the sound waves at one or more locations spaced from the speaker.

21. The method of directing the sound from a speaker in a hand-held device according to claim 18, wherein said adjusting includes absorbing a selected frequency of the sound waves to thereby filter the selected frequency.
